(19) United States
(12) Patent Application Publication
(10) Pub. No.: US 2014/0339321 A1
(43) Pub. Date: Nov. 20, 2014

(54) PRESSURE FEED CONTAINER, STORAGE METHOD USING THE PRESSURE FEED CONTAINER, AND METHOD FOR TRANSFERRING LIQUID USING THE PRESSURE FEED CONTAINER

(71) Applicant: CENTRAL GLASS COMPANY, LIMITED, Yamaguchi (JP)

(72) Inventors: Atsushi RYOKAWA, Yamaguchi (JP); Shuhei YAMADA, Yamaguchi (JP); Masahiro FUJITANI, Yamaguchi (JP); Yosuke HASHIMOTO, Yamaguchi (JP); Chiaki IDETA, Yamaguchi (JP); Soichi KUMON, Mie (JP); Masanori SAITO, Mie (JP); Takashi SAIO, Mie (JP)

(73) Assignee: CENTRAL GLASS COMPANY, LIMITED, Yamaguchi (JP)

(21) Appl. No.: 14/280,964

(22) Filed: May 19, 2014

(30) Foreign Application Priority Data
May 20, 2013 (JP) 2013-106428
May 12, 2014 (JP) 2014-098680

(51) Int. Cl. B05B 9/04; B65B 31/00

(52) U.S. Cl. CPC B05B 9/04; B65B 31/00
USPC 239/1; 239/373; 53/432

(57) ABSTRACT

The present invention provides a pressure feed container capable of ensuring the cleanliness of a liquid such as a protective film-forming liquid chemical or a protective film-forming liquid chemical kit for preparing the liquid chemical even after long-term storage, and also capable of suppressing electrostatic charge in the liquid. The present invention provides a pressure feed container configured to store a protective film-forming liquid chemical or a protective film-forming liquid chemical kit that is mixed into the protective film-forming liquid chemical, and to transfer a liquid upon application of pressure to the inside of the container, the protective film-forming liquid chemical being for forming a water-repellent protective film on at least surfaces of recessed portions of an uneven pattern formed on a surface of a wafer containing a silicon element at least at a part of the uneven pattern. The protective film-forming liquid chemical contains a nonaqueous organic solvent, a silylation agent, and an acid or a base; the protective film-forming liquid chemical kit includes a treatment liquid A containing a nonaqueous organic solvent and a silylation agent, and a treatment liquid B containing a nonaqueous organic solvent and an acid or a base; the pressure feed container includes a container body configured to contain a liquid selected from the protective film-forming liquid chemical, the treatment liquid A, and the treatment liquid B, and a liquid flowing nozzle configured such that the liquid flows therethrough to be introduced into the container body and/or to be extracted from the container body; the container body includes a metal can body in which a portion configured to contact the liquid is formed from a resin material; the liquid flowing nozzle is provided with a neutralization mechanism configured to reduce electrostatic potential in the liquid; and a liquid contact portion of the liquid flowing nozzle excluding the neutralization mechanism is formed from a resin material.

### TECHNICAL FIELD

The present invention relates to a pressure feed container, a storage method using the pressure feed container, and a method for transferring a liquid using the pressure feed container. More specifically, the present invention relates to a pressure feed container configured to store a water-repellent protective film-forming liquid chemical or a water-repellent protective film-forming liquid chemical kit for improving a cleaning step in the manufacture of semiconductor devices or the like. The cleaning step tends to cause collapse of an uneven pattern formed on the surface of a wafer containing a silicon element at least at a part of the uneven pattern.

### BACKGROUND ART

Semiconductor devices for use in electrical communication networks and digital household electric appliances are required to have higher performance, higher functionality, and lower power consumption. Consequently, the circuit patterns are becoming smaller, and the size of particles that reduce the manufacturing yield is also becoming smaller. As a result, a cleaning step for removing contaminants such as micro-sized particles is frequently performed. Consequently, the cleaning step accounts for 30 to 40% of the entire semiconductor manufacturing process.

On the other hand, there is a problem arising from cleaning as conventionally performed with an ammonia-mixed cleaning agent. That is, as the circuit patterns become smaller, more damage is caused to the wafer due to the basicity of such an agent. Thus, the use of a less damaging agent, such as a dilute hydrofluoric acid-based cleaning agent, has been promoted as an alternative to the conventional agent.

The alternative has alleviated damage to the wafer caused by cleaning; however, problems due to a higher aspect ratio associated with smaller semiconductor devices have become obvious. In other words, a phenomenon where a pattern collapses when a gas-liquid interface passes through the pattern occurs after cleaning or rinsing, significantly reducing the yield. This phenomenon has been a serious problem.

Such pattern collapse occurs at the time of removing a cleaning liquid or a rinsing liquid from the wafer surface. The reason thereof is considered as follows: a difference in height of residual liquid is created between a part having a high aspect ratio and a part having a low aspect ratio, making a difference in capillary force that acts on the pattern.

Thus, pattern collapse is expected to be solved by reducing the capillary force to decrease the difference in capillary force created by the difference in height of residual liquid. The capillary force is the absolute value of P obtained by the equation shown below, and it is expected from this equation that the capillary force can be reduced by decreasing γ or cos θ:

P=2×γ×cos θ/S

where γ is the surface tension, θ is the contact angle, and S is the pattern size (width of the recessed portion).

Patent Literatures 1 to 5 disclose the use of a water-repellent cleaning liquid or the like that imparts water repellency to at least recessed portions of an uneven pattern of a silicon wafer so as to improve the cleaning step that tends to cause pattern collapse.

In the field of the manufacture of semiconductor devices, a cleaning liquid and the like used in the cleaning step must be of high purity. Thus, containers for storing liquids such as a cleaning liquid are required to maintain the high purity of these liquids.

Patent Literature 6 discloses a container, wherein a liquid to be stored is introduced into a container body through an inlet tube so as to prevent scattering of the liquid at the bottom and to prevent electrostatic charge from being generated by bubbles. Patent Literature 7 discloses a container for transferring and storing a liquid, wherein the container includes a static electricity removing device protected from external mechanical influences. Patent Literature 8 discloses a tank lined with fluorine resin, wherein the tank includes insulating materials at welded portions so as to suppress an increase in the temperature of lining materials during welding and to prevent breakage of the lining materials. Patent Literature 9 discloses a container capable of containing monochlorosilane in a stable state. Patent Literature 10 discloses a device and a process for storing and dispensing chemical reagents and compositions while suppressing the generation of microbubbles and the occurrence of particle contamination.

### CITATION LIST

### Patent Literature

Patent Literature 1: JP-A 2010-192878
Patent Literature 2: JP-A 2010-192879
Patent Literature 3: JP-A 2010-272852
Patent Literature 4: JP-A 2012-033873
Patent Literature 5: JP-A 2012-033881
Patent Literature 6: JP-A 2010-023849
Patent Literature 7: JP-A 2012-071894
Patent Literature 8: JP-A 2003-170994
Patent Literature 9: JP-A 2012-006827
Patent Literature 10: JP-T 2008-539146

### SUMMARY OF INVENTION

### Technical Problem

Patent Literatures 1 to 5 disclose a water-repellent protective film-forming liquid chemical (hereinafter sometimes referred to as a “protective film-forming liquid chemical” or simply as a “liquid chemical”) for forming a water-repellent protective film on at least surfaces of recessed portions of an uneven pattern formed on the surface of a wafer. As described above, a container for storing such a liquid chemical is required to maintain the cleanliness of the liquid chemical even after long-term storage of the liquid chemical.

Further, the liquid chemical stored in a container is discharged to the outside upon application of pressure to the inside of the container with a gas such as nitrogen. Therefore, the liquid chemical is often stored in a pressure feed container having airtightness. A material of the pressure feed container is limited to a material such as a metal material in view of safety as prescribed in, for example, Industrial Safety and Health Act and Fire Service Act in Japan. However, some of the liquid chemicals are corrosive to the material of the container, and thus, in order to prevent a large amount of metal impurities derived from the container from dissolving into the liquid chemical, the following method is employed: a method in which the inside of the container is lined with a resin material such as fluorine resin; or a method in which a fluorine resin tank (resin can body) is formed by a method such as rotational molding, blow molding, or isostatic pressing; and then the exterior of the tank is covered with a metal can body.

However, unlike metal materials, resin materials are electrically insulating, so that, unfortunately, the liquid chemical tends to be electrostatically charged while the liquid chemical is introduced into or extracted from the container to which resin lining has been applied. An increase in electrostatic potential in the liquid chemical may cause electrification to human body when in contact with the container or the like. It may also start a fire from a spark (spark current) or cause damage to the container.

In Patent Literature 6 and Patent Literature 7, the cleanliness and airtightness of the container are not considered, and the effect of suppressing electrostatic potential was sometimes insufficient. In Patent Literature 8, the cleanliness, airtightness, and effect of suppressing electrostatic potential are not considered. In Patent Literature 9, the cleanliness and effect of suppressing electrostatic potential are not considered. In Patent Literature 10, the effect of suppressing electrostatic potential is not considered.

The present invention aims to provide a pressure feed container capable of ensuring the cleanliness of a liquid such as a protective film-forming liquid chemical or a protective film-forming liquid chemical kit for preparing the liquid chemical even after long-term storage, and also capable of suppressing electrostatic charge in the liquid; a storage method using the pressure feed container; and a method for transferring a liquid using the pressure feed container.

### Solution to Problem

The pressure feed container of the present invention is defined as follows:

a pressure feed container configured to store a protective film-forming liquid chemical or a protective film-forming liquid chemical kit that is mixed into the protective film-forming liquid chemical, and to transfer a liquid upon application of pressure to the inside of the container, the protective film-forming liquid chemical being for forming a water-repellent protective film on at least surfaces of recessed portions of an uneven pattern formed on a surface of a wafer containing a silicon element at least at a part of the uneven pattern (hereinafter such a wafer having an uneven pattern is sometimes simply referred to as a “wafer”),

the protective film-forming liquid chemical containing a nonaqueous organic solvent, a silylation agent, and an acid or a base,

the protective film-forming liquid chemical kit including a treatment liquid A containing a nonaqueous organic solvent and a silylation agent, and a treatment liquid B containing a nonaqueous organic solvent and an acid or a base,

the pressure feed container including a container body configured to contain a liquid selected from the protective film-forming liquid chemical, the treatment liquid A, and the treatment liquid B, and a liquid flowing nozzle configured such that the liquid flows therethrough to be introduced into the container body and/or to be extracted from the container body,

the container body including a metal can body in which a portion configured to contact the liquid is formed from a resin material, and

the liquid flowing nozzle being provided with a neutralization mechanism configured to reduce electrostatic potential in the liquid, and a liquid contact portion of the liquid flowing nozzle excluding the neutralization mechanism being formed from a resin material.

The pressure feed container of the present invention is configured to transfer a liquid upon application of pressure to the inside of the container, and to store a protective film-forming liquid chemical (hereinafter sometimes simply referred to as a “liquid chemical”) or a protective film-forming liquid chemical kit that is mixed into the protective film-forming liquid chemical (hereinafter sometimes simply referred to as a “liquid chemical kit”) for forming a water-repellent protective film on at least surfaces of recessed portions of an uneven pattern formed on a surface of a wafer. While the pressure feed container of the present invention is formed from a metal material for ensuring safety, a large part of a portion configured to contact a liquid (the protective film-forming liquid chemical, the treatment liquid A, or the treatment liquid B) is formed from a resin material. Therefore, particles of metal impurities derived from the container do not dissolve into the liquid, and the cleanliness of the liquid can thus be ensured. The pressure feed container of the present invention is further configured such that the liquid flowing nozzle through which the liquid is introduced into or extracted from the container body is provided with the neutralization mechanism, so that the pressure feed container can reduce electrostatic potential in the liquid.

In the pressure feed container of the present invention, the neutralization mechanism is preferably formed from a grounded conductive material. The neutralization mechanism may be formed such that, in the liquid flowing nozzle, a part of a surface configured to contact the liquid is formed from a grounded conductive material. The neutralization mechanism may also be formed by providing a grounded conductive material in the liquid flowing nozzle such that the neutralization mechanism is configured to contact the liquid.

In the pressure feed container of the present invention, the container body is preferably further provided with a neutralization mechanism configured to reduce electrostatic potential in the liquid. The neutralization mechanism preferably includes a rod-like body in which a grounded conductive material is used to form a part of a surface configured to contact the liquid, and a resin material is used to form a liquid contact portion other than the conductive material.

In the pressure feed container of the present invention, the container body includes a metal can body having an inner surface to which resin lining has been applied, or a metal can body covering an exterior of a resin can body.

The storage method of the present invention is defined as follows:

a method for storing a protective film-forming liquid chemical or a protective film-forming liquid chemical kit that is mixed into the protective film-forming liquid chemical in a pressure feed container, the protective film-forming liquid chemical being for forming a water-repellent protective film on at least surfaces of recessed portions of an uneven pattern formed on a surface of a wafer containing a silicon element at least at a part of the uneven pattern,

the protective film-forming liquid chemical containing a nonaqueous organic solvent, a silylation agent, and an acid or a base,

the protective film-forming liquid chemical kit including a treatment liquid A containing a nonaqueous organic solvent and a silylation agent, and a treatment liquid B containing a nonaqueous organic solvent and an acid or a base,

the method including:

introducing a liquid selected from the protective film-forming liquid chemical, the treatment liquid A, and the treatment liquid B into the pressure feed container of the present invention while applying pressure to the pressure feed container with an inert gas such that the pressure feed container has an internal pressure of 0.01 to 0.19 MPa in gauge pressure at 45° C.; and

storing the liquid in a temperature range from 0° C. to 45° C.

The method for transferring a liquid of the present invention is defined as follows:

a method for transferring a protective film-forming liquid chemical or a protective film-forming liquid chemical kit that is mixed into the protective film-forming liquid chemical by using a pressure feed container configured to transfer a liquid upon application of pressure, the protective film-forming liquid chemical being for forming a water-repellent protective film on at least surfaces of recessed portions of an uneven pattern formed on a surface of a wafer containing a silicon element at least at a part of the uneven pattern,

the protective film-forming liquid chemical containing a nonaqueous organic solvent, a silylation agent, and an acid or a base,

the protective film-forming liquid chemical kit including a treatment liquid A containing a nonaqueous organic solvent and a silylation agent, and a treatment liquid B containing a nonaqueous organic solvent and an acid or a base,

the pressure feed container including a container body configured to contain a liquid selected from the protective film-forming liquid chemical, the treatment liquid A, and the treatment liquid B,

the container body including a metal can body in which a portion configured to contact the liquid is formed from a resin material, and

the method including at least one of (1) and (2) below:

(1) introducing the liquid into the container body through a liquid flowing portion provided with a neutralization mechanism configured to reduce electrostatic potential in the liquid, wherein a liquid contact portion of the liquid flowing portion excluding the neutralization mechanism is formed from a resin material; and

(2) extracting the liquid from the container body containing the liquid through a liquid flowing portion provided with a neutralization mechanism configured to reduce electrostatic potential in the liquid, wherein a liquid contact portion of the liquid flowing portion excluding the neutralization mechanism is formed from a resin material.

A pressure feed container for use in the method for transferring a liquid of the present invention may be the pressure feed container of the present invention provided with a neutralization mechanism, or a pressure feed container not provided with a neutralization mechanism. In the case where the pressure feed container of the present invention is used, the liquid flowing nozzle corresponds to the liquid flowing portion. In the case where a pressure feed container not provided with a neutralization mechanism is used, a pipe or the like provided with a neutralization mechanism corresponds to the liquid flowing portion.

In the method for transferring a liquid of the present invention, the neutralization mechanism is preferably formed from a grounded conductive material. The neutralization mechanism may be formed such that, in the liquid flowing portion, a part of a surface configured to contact the liquid is formed from a grounded conductive material. The neutralization mechanism may also be formed by providing a grounded conductive material in the liquid flowing portion such that the neutralization mechanism is configured to contact the liquid.

In the method for transferring a liquid of the present invention, the neutralization mechanism contacts the liquid for 0.001 to 100 seconds.

In the method for transferring a liquid of the present invention, the liquid flows through the liquid flowing portion at a rate of 0.01 to 10 m/sec.

### Advantageous Effects of Invention

The pressure feed container of the present invention can ensure the cleanliness of a liquid such as a protective film-forming liquid chemical or a protective film-forming liquid chemical kit for preparing the liquid chemical even after long-term storage, and can also suppress electrostatic charge in the liquid.

### BRIEF DESCRIPTION OF DRAWINGS

FIG. 1 is a schematic cross-sectional view showing an example of a pressure feed container of the present invention.

FIG. 2 is a cross-sectional view showing a pressure feed container of Examples 1 and 2.

FIG. 3 is a cross-sectional view showing a pressure feed container of Examples 3 and 4.

FIG. 4 is a cross-sectional view showing a pressure feed container of Example 5.

FIG. 5 is a cross-sectional view showing a pressure feed container of Comparative Example 1.

FIG. 6 is a cross-sectional view showing a pressure feed container of Comparative Example 2.

FIG. 7 is a cross-sectional view showing a pressure feed container of Examples 31 and 32.

FIG. 8 is a cross-sectional view showing a pressure feed container of Examples 33 and 34.

FIG. 9 is a cross-sectional view showing a pressure feed container of Example 35.

FIG. 10 is a cross-sectional view showing a pressure feed container of Comparative Example 13.

### DESCRIPTION OF EMBODIMENTS

The present invention is specifically described based on, but not limited to, embodiments below. The embodiments may be appropriately modified as long as the gist of the present invention is not changed.

### [Pressure Feed Container]

The following describes a pressure feed container of the present invention. The pressure feed container of the present invention is a container configured to store a protective film-forming liquid chemical or a protective film-forming liquid chemical kit that is mixed into the protective film-forming liquid chemical, the protective film-forming liquid chemical being for forming a water-repellent protective film on at least surfaces of recessed portions of an uneven pattern formed on a surface of a wafer containing a silicon element at least at a part of the uneven pattern. The protective film-forming liquid chemical includes a nonaqueous organic solvent, a silylation agent, and an acid or a base. The protective film-forming liquid chemical kit includes a treatment liquid A containing a nonaqueous organic solvent and a silylation agent, and a treatment liquid B containing a nonaqueous organic solvent and an acid or a base. The protective film-forming liquid chemical, the treatment liquid A, and the treatment liquid B to be stored in the pressure feed container of the present invention will be described later in detail.

The water-repellent protective film in the present invention means a film formed on a wafer surface so as to reduce the wettability of the surface, i.e., a film imparting water repellency. The water repellency in the present invention means properties to reduce the surface energy of a surface of an article to thereby reduce interaction, such as hydrogen bonds or intermolecular forces, between water or another liquid and the surface of the article (i.e., at the interface). The effect of reducing the interaction is particularly large for water, but it is also exhibited for a mixed liquid of water and a non-water liquid or for a non-water liquid. The reduction of the interaction can increase the contact angle between the surface of the article and the liquid. Hereinafter, the water-repellent protective film may also be referred to simply as “a protective film”. The water-repellent protective film may be formed of a water-repellent protective film-forming agent described later or may include a reaction product mainly containing the water-repellent protective film-forming agent.

If a wafer is treated with the liquid chemical or a liquid chemical prepared from the liquid chemical kit, after a cleaning liquid is removed from, i.e., dried out of the recessed portions of the uneven pattern of the wafer, the protective film is formed at least on surfaces of the recessed portions. Thus, the capillary force of the surfaces of the recessed portions decreases so that pattern collapse is less likely to occur. The treatment of a wafer with the liquid chemical means formation of a protective film on at least surfaces of recessed portions of an uneven pattern of a wafer while the liquid chemical or a liquid chemical prepared from the liquid chemical kit is retained on at least the recessed portions. The treatment of a wafer may be performed in any manner as long as the liquid chemical can be retained on at least the recessed portions of the uneven pattern of the wafer. For example, the treatment may be a single wafer processing, typically a spin treatment in which wafers are treated one by one by rotating each wafer, which is held almost horizontally, and simultaneously supplying a liquid chemical to near the pivot of the rotation. Alternatively, the treatment may be a batch wafer processing in which a plurality of wafers are treated by immersing them in a treating bath. The liquid chemical to be supplied to the recessed portions of the uneven pattern of the wafer may be in any form as long as the liquid chemical is in a liquid form when retained on the recessed portions. The form may be, for example, liquid or vapor.

FIG. 1 is a schematic cross-sectional view showing an example of the pressure feed container of the present invention. A pressure feed container 20 shown in FIG. 1 includes a container body 21 to which a liquid is introduced, a liquid flowing nozzle 22 to allow a liquid to flow therethrough, and a gas-port nozzle 23 to allow gas to flow therethrough. The liquid flowing nozzle 22 and the gas-port nozzle 23 each are connected to the container body 21. The liquid flowing nozzle 22 is connected to a liquid contact nozzle 25 to contact the liquid in the container body 21. The liquid flowing nozzle 22 is provided with a neutralization mechanism 26 to reduce electrostatic potential in the liquid. The liquid flowing nozzle 22 and the gas-port nozzle 23 each are also connected to a member, such as a valve or a coupler (not shown).

Examples of the material of a liquid contact portion of the member such as a valve or a coupler include resin materials such as high density polyethylene (HDPE), polypropylene (PP), 6,6-nylon, tetrafluoroethylene (PTFE), copolymers of tetrafluoroethylene and perfluoro alkyl vinyl ether (PFA), polychlorotrifluoroethylene (PCTFE), copolymers of ethylene and chlorotrifluoroethylene (ECTFE), copolymers of ethylene and tetrafluoroethylene (ETFE), and copolymers of tetrafluoroethylene and hexafluoropropylene (FEP). PTFE, PFA, and ETFE are preferable, and PTFE and PFA are more preferable among these. Other examples of the material of a liquid contact portion of the member such as a valve or a coupler include metal such as steel, alloyed cast iron, maraging steel, stainless steel (such as electrolytically-polished SUS304 or SUS316L), nickel and its alloys, cobalt and its alloys, aluminum, magnesium and its alloys, copper and its alloys, titanium, zirconium, tantalum, niobium and its alloys, lead and its alloys, noble metal (e.g., gold, silver, platinum, palladium, rhodium, iridium, ruthenium, osmium) and its alloys. Stainless steel is preferable among the examples in view of the corrosion resistance and the cost efficiency. The linear velocity at the member such as a valve or a coupler tends to increase due to a narrow channel of a liquid flowing portion, leading to easy electrification. Thus, at least a part of the liquid contact portion of the member such as a valve or a coupler is preferably formed from the aforementioned metal materials in view of neutralization.

The members may be connected to each other via a flange or by welding. In the pressure feed container 20 shown in FIG. 1, a member integrally connected to the container body 21 is connected via a flange to the neutralization mechanism 26 so that the liquid flowing nozzle 22 is formed. In the pressure feed container of the present invention, the entire liquid flowing nozzle may be integrally connected to the container body.

In the pressure feed container of the present invention, the liquid flowing nozzle is a nozzle to introduce a liquid into the container body and/or to extract a liquid from the container body. The gas-port nozzle is a nozzle to introduce air into the container body and/or to extract air from the container body. The liquid introduced into or extracted from the container body is the liquid chemical, the treatment liquid A, or the treatment liquid B. The air introduced into or extracted from the container body is, for example, an inert gas, and especially preferably nitrogen gas.

In the pressure feed container of the present invention, the container body includes a metal can body in which a portion configured to contact the liquid is formed from a resin material. The container body may include a metal can body having an inner surface to which resin lining has been applied, or a metal can body covering an exterior of a resin can body. FIG. 1 shows a container body 21 in which the inner surface of a metal can body is covered with a resin lining layer 24. Hereinafter, the “resin lining layer” may also be referred simply as “lining layer”.

In the pressure feed container of the present invention, the resin lining layer has a thickness of preferably 1 to 10 mm, and more preferably 1.5 to 6 mm. The resin can body has a thickness of preferably 1 to 10 mm, and more preferably 1.5 to 5 mm.

Specific examples of the resin materials include high density polyethylene (HDPE), polypropylene (PP), 6,6-nylon, tetrafluoroethylene (PTFE), copolymers of tetrafluoroethylene and perfluoro alkyl vinyl ether (PFA), polychlorotrifluoroethylene (PCTFE), copolymers of ethylene and chlorotrifluoroethylene (ECTFE), copolymers of ethylene and tetrafluoroethylene (ETFE), and copolymers of tetrafluoroethylene and hexafluoropropylene (FEP). PTFE, PFA, and ETFE are preferable, and PTFE and PFA are more preferable among these.

The metal can body may be formed from any metal material. Examples of the metal material include steel, alloyed cast iron, maraging steel, stainless steel (such as electrolytically-polished SUS304 or SUS316L), nickel and its alloys, cobalt and its alloys, aluminum, magnesium and its alloys, copper and its alloys, titanium, zirconium, tantalum, niobium and its alloys, lead and its alloys, noble metal (e.g., gold, silver, platinum, palladium, rhodium, iridium, ruthenium, osmium) and its alloys. In view of corrosion resistance and cost efficiency, stainless steel is preferable among these.

In the pressure feed container of the present invention, preferably, the liquid flowing nozzle and the gas-port nozzle are preferably formed from the aforementioned metal materials, and the portion configured to contact the liquid is preferably formed from the aforementioned resin material. For example, in the pressure feed container 20 shown in FIG. 1, the inner surface of the liquid flowing nozzle 22 is covered with the resin lining layer 24, and the inner surface of the gas-port nozzle 23 is covered with the resin lining layer 24. Moreover, the liquid flowing nozzle 22 is connected to the liquid contact nozzle 25. At least the surface of the liquid contact nozzle 25 to contact the liquid in the container body 21 is formed from resin.

If the portion to contact the liquid is formed from the resin material as mentioned earlier, metals are not dissolved into the liquid, suppressing the increase in the number of particles in the liquid. Thus, the liquid can remain clean.

The number of particles larger than 0.2 μm in a liquid phase of the liquid chemical, measured using a light scattering liquid-borne particle counter, is preferably not more than 100 per mL of the liquid chemical in view of the cleanliness of the liquid chemical. If the number of particles larger than 0.2 μm exceeds 100 per mL of the liquid chemical, pattern damage due to particles may be induced, which unfavorably causes a decrease in the device yield and reduces the reliability. If the number of particles larger than 0.2 μm is not more than 100 per mL of the liquid chemical, washing with a solvent or water after formation of the protective film can favorably be omitted or reduced. The number of particles larger than 0.2 μm is preferably as small as possible but may be one or more per mL of the liquid chemical. The number of particles larger than 0.2 μm in a liquid phase of the treatment liquid A included in the liquid chemical kit, measured using a light scattering liquid-borne particle counter, is preferably not more than 100 per mL of the treatment liquid A, and the number of such particles in a liquid phase of the treatment liquid B is preferably not more than 100 per mL of the treatment liquid B. This is because, if the number of particles in the liquid phase of the treatment liquid A and that in the liquid phase of the treatment liquid B are within the above range, the number of particles contained in a liquid chemical prepared from the liquid chemical kit is easily controlled to be not more than 100 per mL of the liquid chemical. The particles in the liquid phase of the liquid chemical or the liquid phase of the treatment liquid in the present invention are measured with a commercially available measurement device of a laser light scattering liquid-borne particle counting system. The particle size means the polystyrene latex (PSL) light-scattering equivalent size.

The particles mean particles of those remaining undissolved in the final product of the liquid chemical or treatment liquid. Examples of such particles include particulate impurities contained in the raw materials, such as dirt, dust, organic solid matter and inorganic solid matter, and particulate contaminants mixed during the preparation of the liquid chemical or treatment liquid, such as dirt, dust, organic solid matter and inorganic solid matter.

If all the portions to contact the liquid are formed from resin, the contact between the liquid and the resin tends to increase the electrostatic potential in the liquid. This tendency is especially higher when the liquid includes a larger amount of nonaqueous organic solvent. Taking this into consideration, the pressure feed container of the present invention characteristically includes a neutralization mechanism to reduce electrostatic potential in the liquid at the liquid flowing nozzle. The structure of the neutralization mechanism will be described later. Liquid contact portions of the liquid flowing nozzle excluding the neutralization mechanism are formed from resin materials.

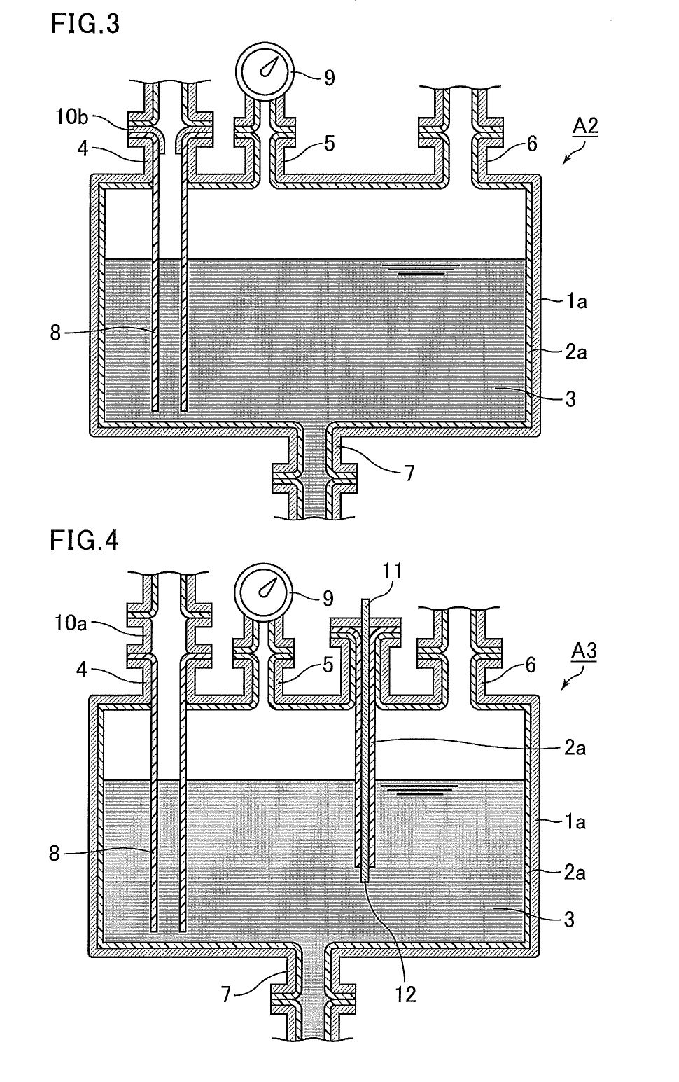

For reducing electrostatic potential in the liquid, the liquid is preferably allowed to contact a grounded conductive material in the liquid flowing nozzle. Thus, the neutralization mechanism is preferably formed from a grounded conductive material. In this case, the neutralization mechanism is more preferably formed such that a part of a surface of the liquid flowing nozzle configured to contact the liquid is formed from a grounded conductive material, or the neutralization mechanism is more preferably formed by providing a grounded conductive material in the liquid flowing nozzle such that the neutralization mechanism is configured to contact the liquid. Examples of the neutralization mechanism include those having any of the following structures: (a) a member formed from a conductive material is connected as a part of the liquid flowing nozzle as shown in FIG. 1; (b) the liquid flowing nozzle has a part without a resin lining layer so that a conductive material is exposed; and (c) a member formed from a conductive material is provided in the liquid flowing nozzle covered with a resin lining layer as shown in FIG. 3 as described later. The member formed from a conductive material is not particularly limited, and examples thereof include a sleeve member and a washer member. The liquid flowing nozzle may include a plurality of neutralization mechanisms. In the case of a plurality of neutralization mechanisms, they may be of the same kinds, or a combination of different kinds.

Examples of the conductive material include steel, alloyed cast iron, maraging steel, stainless steel (such as electrolytically-polished SUS304 or SUS316L), nickel and its alloys, cobalt and its alloys, aluminum, magnesium and its alloys, copper and its alloys, titanium, zirconium, tantalum, niobium and its alloys, lead and its alloys, noble metal (e.g., gold, silver, platinum, palladium, rhodium, iridium, ruthenium, osmium) and its alloys, diamond, and glassy carbon. The conductive material may also be a resin material in which the above conductive material, for example carbon, is contained (mixed therein). Examples of the resin material include “Naflon PFA-AS tube” (trade name) produced by Nichias Co., Jp and “Neoflon PFA-AP-210AS, PFA-AP-230AS, PFA-AP-230ASL” (trade name) produced by Daikin Industries, Ltd. The conductive material is preferably one causing little dissolution of the metal into the liquid. For example, the conductive material is preferably selected from those satisfying the following: in an immersion test where a test specimen of a conductive material contacts the liquid at 45° C. for 700 hours, the amounts of elements, Na, Mg, K, Ca, Mn, Fe, Cu, Li, Al, Cr, Ni, Zn, and Ag, per unit area of the test specimen dissolved into the liquid are obtained and calculated for conversion to concentrations under actual facility conditions (contact area between the liquid and the conductive material, the amount of the liquid processed), and the concentration of each element, Na, Mg, K, Ca, Mn, Fe, Cu, Li, Al, Cr, Ni, Zn, or Ag, is lower than 0.01 ppb by mass of the element, or lower than the minimum detection limit for the element whose minimum detection limit is not less than 0.01 ppb by mass. The minimum detection limit herein refers to a concentration lower than a detection limit defined by a larger one of the following two concentrations: a concentration obtained by performing a blank test six times to give a standard deviation of the detected concentrations and then multiplying the standard deviation by 10, and a concentration relative to a response value corresponding to a five-fold of the noise of an inductively coupled plasma mass spectrometry. The conductive material having a higher electrical conductivity is more preferred. In view of the above, the conductive material is particularly preferably stainless steel, gold, platinum, diamond, glassy carbon, or the like. For the cleanliness of the liquid, the conductive material is preferably electropolished one, and more preferably electropolished stainless steel.

In the pressure feed container of the present invention, the neutralization mechanism disposed on the liquid flowing nozzle may have any size. However, if it is too small, the effect to reduce electrostatic potential in the liquid is insufficient. If it is too big, metal dissolution occurs to increase the particles, so that the cleanliness of the liquid is hardly maintained. In consideration of this, the neutralization mechanism preferably has a portion to contact the liquid having an area that allows the contact with the liquid for preferably 0.001 to 100 seconds, more preferably 0.01 to 10 seconds, and still more preferably 0.01 to 1 second.

The pressure feed container of the present invention is preferably further provided with a neutralization mechanism to reduce electrostatic potential in the liquid in the container body. The neutralization mechanism can reduce electrostatic potential in the liquid when it contact the liquid in the container body. The neutralization mechanism provided in the container body has any structure but preferably includes a rod-like body in which a grounded conductive material is used to form a part of a surface configured to contact the liquid, and a resin material is used to form a liquid contact portion other than the conductive material.

The neutralization mechanism provided in the container body of the pressure feed container of the present invention may have any size. However, if it is too small, the effect to reduce electrostatic potential in the liquid is insufficient. If it is too big, metal dissolution occurs to increase the particles, so that the cleanliness of the liquid is hardly maintained. In consideration of this, the neutralization mechanism preferably has a portion to contact the liquid having an area of preferably 1 to 100,000 mm², more preferably 10 to 10,000 mm², and still more preferably 10 to 1,000 mm².

The electrostatic potential can be measured with, for example, an electrostatic potential meter. For reference, regarding an indicator for controlling the electrostatic potential in the liquid chemical or the liquid chemical kit, if the minimum ignition energy in the liquid is less than 0.1 mJ, the electrostatic potential in the liquid is preferably adjusted to not more than 1 kV; if the energy is not less than 0.1 mJ but less than 1 mJ, the electrostatic potential is preferably adjusted to not more than 5 kV; and if the energy is not less than 1 mJ, the electrostatic potential is preferably adjusted to not more than 10 kV, as described on p. 88 of “Guidance for Static Electricity Safety, 2007” published by the National Institute of Occupational Safety and Health, Japan. The lower the electrostatic potential is, the less likely the liquid chemical or the liquid chemical kit to be obtained ignites, and thus more preferable in view of safety.

The pressure feed container of the present invention is configured to transfer a liquid upon application of pressure to the inside of the container. For example, in the pressure feed container 20 shown in FIG. 1, the liquid flowing nozzle 22 and gas-port nozzle 23 are each connected to a valve, a coupler or the like (not shown), and the members of the pressure feed container 20 are connected such that the inside of the pressure feed container 20 is sealed.

In the pressure feed container of the present invention, in order to maintain the performance of the liquid and the like, the rate of change of the inner pressure at 45° C. after 12-month storage at 45° C. relative to the initial inner pressure at 45° C. immediately after introducing the liquid chemical, treatment liquid A or treatment liquid B while applying pressure is preferably not more than ±10%. Also, the pressure after the storage preferably achieves airtightness exceeding the atmospheric pressure. Moreover, the initial inner pressure at 45° C. is preferably a gauge pressure of 0.01 to 0.19 MPa, and more preferably a gauge pressure of 0.03 to 0.1 MPa.

The airtightness is achieved by a known method. For example, a valve such as a diaphragm valve, a needle valve, a gate valve, a globe valve, a ball valve, or a butterfly valve can be used. A diaphragm valve, which has excellent airtightness and a structure not contaminating a fluid, is especially preferably used.

The volume and kinds of the pressure feed container of the present invention are not particularly limited. Examples of the container include a cylindrical pressure feed container with a capacity of about 200 L and a container-shaped pressure feed container with a capacity of about 1000 L.

In the pressure feed container of the present invention, the liquid flowing nozzle is a nozzle for introducing and/or extracting a liquid. The introduction and/or extraction of a liquid may be performed by one nozzle or by separately two or more nozzles. Similarly, the gas-port nozzle is a nozzle for introducing and/or extracting air. The introduction and/or extraction of air may be performed by one nozzle or by separately two or more nozzles.

In the case where the pressure feed container of the present invention has two liquid flowing nozzles, both of the liquid flowing nozzles are each preferably provided with the neutralization mechanism. However, it is sufficient that one of the liquid flowing nozzles is provided with the neutralization mechanism. In the case where one of the liquid flowing nozzles is provided with the neutralization mechanism, the neutralization mechanism is preferably provided in a liquid flowing nozzle for introducing a liquid. In the case where the pressure feed container of the present invention has two or more liquid flowing nozzles, all the liquid flowing nozzles are each preferably provided with the neutralization mechanism. However, it is sufficient that at least one of the liquid flowing nozzles is provided with the neutralization mechanism.

The pressure feed container of the present invention may include a nozzle other than the liquid flowing nozzle 22, the gas-port nozzle 23, and the liquid contact nozzle 25 shown in FIG. 1. Examples of the other nozzle include a nozzle which connects the pressure feed container with a manometer for measuring the pressure in the container body.

The following describes the protective film-forming liquid chemical and the protective film-forming liquid chemical kit to be stored in the pressure feed container of the present invention. As described earlier, the protective film-forming liquid chemical includes a nonaqueous organic solvent, a silylation agent, and an acid or a base, while the protective film-forming liquid chemical kit includes a treatment liquid A containing a nonaqueous organic solvent and a silylation agent, and a treatment liquid B containing a nonaqueous organic solvent and an acid or a base.

Specific examples of the nonaqueous organic solvent in the liquid chemical include: hydrocarbons such as toluene, benzene, xylene, hexane, heptane, and octane; esters such as ethyl acetate, propyl acetate, butyl acetate, and ethyl acetoacetate; ethers such as diethyl ether, dipropyl ether, dibutyl ether, tetrahydrofuran, and dioxane; ketones such as acetone, acetylacetone, methyl ethyl ketone, methyl propyl ketone, methyl butyl ketone, cyclohexanone, and isophorone; halogen element-containing solvents including perfluorocarbons such as perfluorooctane, perfluorononane, perfluorocyclopentane, perfluorocyclohexane, and hexafluorobenzene, hydrofluorocarbons such as 1,1,1,3,3-pentafluorobutane, octafluorocyclopentane, 2,3-dihydrodecafluoropentane, and ZEORORA-H (produced by ZEON CORPORATION), hydrofluoroethers such as methyl perfluoroisobutyl ether, methyl perfluorobutyl ether, ethyl perfluorobutyl ether, ethyl perfluoroisobutyl ether, ASAHIKLINAE-3000 (produced by Asahi Glass Co., Ltd.), and Novec 7100, Novec 7200, Novec 7300 and Novec 7600 (any of these are produced by 3M Limited), chlorocarbons such as tetrachloromethane, hydrochlorocarbons such as chloroform, chlorofluorocarbons such as dichlorodifluoromethane, hydrochlorofluorocarbons such as 1,1-dichloro-2,2,3,3,3-pentafluoropropane, 1,3-dichloro-1,1,2,2,3-pentafluoropropane, 1-chloro-3,3,3-trifluoropropene, and 1,2-dichloro-3,3,3-trifluoropropene, halogen element-containing solvents such as perfluoroethers and perfluoropolyethers; sulfoxide-based solvents such as dimethyl sulfoxide; lactone-based solvents such as γ-butyrolactone, γ-valerolactone, γ-hexanolactone, γ-heptanolactone, γ-octanolactone, γ-nonanolactone, γ-decanolactone, γ-undecanolactone, γ-dodecanolactone, δ-valerolactone, δ-hexanolactone, δ-octanolactone, δ-nonanolactone, δ-decanolactone, δ-undecanolactone, δ-dodecanolactone, and ε-hexanolactone; carbonate-based solvents such as dimethyl carbonate, ethyl methyl carbonate, diethyl carbonate, and propylene carbonate; alcohols such as methanol, ethanol, propanol, butanol, ethylene glycol, diethylene glycol, 1,2-propanediol, 1,3-propanediol, dipropylene glycol, 1,2-butanediol, 1,3-butanediol, 1,4-butanediol, triethylene glycol, tripropylene glycol, tetraethylene glycol, tetrapropylene glycol, and glycerin; polyalcohol derivatives such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol monopropyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monoethyl ether, tripropylene glycol monopropyl ether, tripropylene glycol monobutyl ether, tetrapropylene glycol monomethyl ether, butylene glycol monomethyl ether, ethylene glycol dimethyl ether, ethylene glycol diethyl ether, ethylene glycol dibutyl ether, ethylene glycol monomethyl ether acetate, ethylene glycol monoethyl ether acetate, ethylene glycol monobutyl ether acetate, ethylene glycol diacetate, diethylene glycol dimethyl ether, diethylene glycol ethyl methyl ether, diethylene glycol diethyl ether, diethylene glycol butyl methyl ether, diethylene glycol dibutyl ether, diethylene glycol monomethyl ether acetate, diethylene glycol monoethyl ether acetate, diethylene glycol monobutyl ether acetate, diethylene glycol diacetate, triethylene glycol dimethyl ether, triethylene glycol diethyl ether, triethylene glycol dibutyl ether, triethylene glycol butyl methyl ether, triethylene glycol monomethyl ether acetate, triethylene glycol monoethyl ether acetate, triethylene glycol monobutyl ether acetate, triethylene glycol diacetate, tetraethylene glycol dimethyl ether, tetraethylene glycol diethyl ether, tetraethylene glycol dibutyl ether, tetraethylene glycol monomethyl ether acetate, tetraethylene glycol monoethyl ether acetate, tetraethylene glycol monobutyl ether acetate, tetraethylene glycol diacetate, propylene glycol dimethyl ether, propylene glycol diethyl ether, propylene glycol dibutyl ether, propylene glycol monomethyl ether acetate, propylene glycol monoethyl ether acetate, propylene glycol monobutyl ether acetate, propylene glycol diacetate, dipropylene glycol dimethyl ether, dipropylene glycol methyl propyl ether, dipropylene glycol diethyl ether, dipropylene glycol dibutyl ether, dipropylene glycol monomethyl ether acetate, dipropylene glycol monoethyl ether acetate, dipropylene glycol monobutyl ether acetate, dipropylene glycol diacetate, tripropylene glycol dimethyl ether, tripropylene glycol diethyl ether, tripropylene glycol dibutyl ether, tripropylene glycol monomethyl ether acetate, tripropylene glycol monoethyl ether acetate, tripropylene glycol monobutyl ether acetate, tripropylene glycol diacetate, tetrapropylene glycol dimethyl ether, tetrapropylene glycol monomethyl ether acetate, tetrapropylene glycol diacetate, butylene glycol dimethyl ether, butylene glycol monomethyl ether acetate, butylene glycol diacetate, and glycerin triacetate; and nitrogen element-containing solvents such as formamide, N,N-dimethylformamide, N,N-dimethylacetamide, N-methyl-2-pyrrolidone, diethylamine, triethylamine, and pyridine.

The nonaqueous organic solvent is preferably at least one selected from the group consisting of hydrocarbons, esters, ethers, ketones, halogen element-containing solvents, sulfoxide-based solvents, lactone-based solvents, carbonate-based solvents, polyalcohol derivatives having no OH group, and nitrogen element-containing solvents having no N—H group. Since the silylation agent is easily reactable with a nonaqueous organic solvent having OH group or N—H group, the use of a nonaqueous organic solvent having OH group or N—H group as the nonaqueous organic solvent may reduce the reactivity of the silylation agent. Thus, the water repellency may be hardly exerted in a short time. Moreover, since the silylation agent is not easily reactable with a nonaqueous organic solvent having neither OH group nor N—H group, the use of a nonaqueous organic solvent having neither OH group nor N—H group as the nonaqueous organic solvent is not likely to reduce the reactivity of the silylation agent. Thus, the water repellency is easily exhibited in a short time. The nonaqueous organic solvent having neither OH group nor N—H group refers to both of nonaqueous polar solvents having neither OH group nor N—H group and nonaqueous nonpolar solvents having neither OH group nor N—H group.

Preferably, the nonaqueous organic solvent consists partly or entirely of a nonflammable nonaqueous organic solvent as this makes the protective film-forming liquid chemical nonflammable or raises the flash point to reduce the risk of the liquid chemical. Most of halogen element-containing solvents are nonflammable, and such nonflammable halogen element-containing solvents can be favorably used as the nonflammable organic solvent.

In view of safety under the fire protection law, a solvent having a flash point higher than 70° C. is preferably used as the nonaqueous organic solvent.

According to “Globally Harmonized System of Classification and Labelling of Chemicals; GHS”, a solvent having a flash point of not higher than 93° C. is defined as “a flammable liquid”. If a solvent having a flash point higher than 93° C., though not a noninflammable solvent, is used as the nonaqueous organic solvent, the protective film-forming liquid chemical tends to have a flash point higher than 93° C. Thus, the liquid chemical is less likely to be classified as “a flammable liquid,” which is more preferable in view of safety.

Most of lactone-based solvents, carbonate-based solvents, and polyalcohol derivatives having no OH group have high flash points. Those solvents are preferably used as they can reduce the risk of the protective film-forming liquid chemical. In view of safety, a solvent having a flash point higher than 70° C. is more preferably used as the nonaqueous organic solvent, and specific examples of such a solvent include: γ-butyrolactone, γ-valerolactone, γ-hexanolactone, γ-heptanolactone, γ-octanolactone, γ-nonanolactone, γ-decanolactone, γ-undecanolactone, γ-dodecanolactone, δ-valerolactone, δ-hexanolactone, δ-octanolactone, δ-nonanolactone, δ-decanolactone, δ-undecanolactone, δ-dodecanolactone, ε-hexanolactone, propylene carbonate, ethylene glycol dibutyl ether, ethylene glycol monobutyl ether acetate, ethylene glycol diacetate, diethylene glycol ethyl methyl ether, diethylene glycol diethyl ether, diethylene glycol butyl methyl ether, diethylene glycol dibutyl ether, diethylene glycol monomethyl ether acetate, diethylene glycol monoethyl ether acetate, diethylene glycol monobutyl ether acetate, diethylene glycol diacetate, triethylene glycol dimethyl ether, triethylene glycol diethyl ether, triethylene glycol dibutyl ether, triethylene glycol butyl methyl ether, triethylene glycol monomethyl ether acetate, triethylene glycol monoethyl ether acetate, triethylene glycol monobutyl ether acetate, triethylene glycol diacetate, tetraethylene glycol dimethyl ether, tetraethylene glycol diethyl ether, tetraethylene glycol dibutyl ether, tetraethylene glycol monomethyl ether acetate, tetraethylene glycol monoethyl ether acetate, tetraethylene glycol monobutyl ether acetate, tetraethylene glycol diacetate, propylene glycol diacetate, dipropylene glycol methyl propyl ether, dipropylene glycol monomethyl ether acetate, dipropylene glycol monoethyl ether acetate, dipropylene glycol monobutyl ether acetate, dipropylene glycol diacetate, tripropylene glycol dimethyl ether, tripropylene glycol diethyl ether, tripropylene glycol dibutyl ether, tripropylene glycol monomethyl ether acetate, tripropylene glycol monoethyl ether acetate, tripropylene glycol monobutyl ether acetate, tripropylene glycol diacetate, tetrapropylene glycol dimethyl ether, tetrapropylene glycol monomethyl ether acetate, tetrapropylene glycol diacetate, butylene glycol diacetate, and glycerin triacetate. A solvent having a flash point higher than 93° C. is still more preferably used as the nonaqueous organic solvent, and specific examples of such a solvent include: γ-butyrolactone, γ-hexanolactone, γ-heptanolactone, γ-octanolactone, γ-nonanolactone, γ-decanolactone, γ-undecanolactone, γ-dodecanolactone, δ-valerolactone, δ-hexanolactone, δ-octanolactone, δ-nonanolactone, δ-decanolactone, δ-undecanolactone, δ-dodecanolactone, ε-hexanolactone, propylene carbonate, ethylene glycol diacetate, diethylene glycol butyl methyl ether, diethylene glycol dibutyl ether, diethylene glycol diacetate, diethylene glycol monomethyl ether acetate, diethylene glycol monoethyl ether acetate, diethylene glycol monobutyl ether acetate, triethylene glycol dimethyl ether, triethylene glycol diethyl ether, triethylene glycol dibutyl ether, triethylene glycol butyl methyl ether, triethylene glycol monomethyl ether acetate, triethylene glycol monoethyl ether acetate, triethylene glycol monobutyl ether acetate, triethylene glycol diacetate, tetraethylene glycol dimethyl ether, tetraethylene glycol diethyl ether, tetraethylene glycol dibutyl ether, tetraethylene glycol monomethyl ether acetate, tetraethylene glycol monoethyl ether acetate, tetraethylene glycol monobutyl ether acetate, tetraethylene glycol diacetate, propylene glycol diacetate, dipropylene glycol diacetate, dipropylene glycol monomethyl ether acetate, dipropylene glycol monoethyl ether acetate, dipropylene glycol monobutyl ether acetate, tripropylene glycol dimethyl ether, tripropylene glycol diethyl ether, tripropylene glycol dibutyl ether, tripropylene glycol monomethyl ether acetate, tripropylene glycol monoethyl ether acetate, tripropylene glycol monobutyl ether acetate, tripropylene glycol diacetate, tetrapropylene glycol dimethyl ether, tetrapropylene glycol monomethyl ether acetate, tetrapropylene glycol diacetate, butylene glycol diacetate, and glycerin triacetate.

The silylation agent in the chemical liquid (hereinafter, the silylation agent in the liquid chemical may also be referred to as “protective film-forming liquid agent”) is preferably at least one selected from the group consisting of silicon compounds represented by the following formula [1]:

(R¹)ₐSi(H)_{b}X¹_{4-a-b} [1]

(In the formula [1], R¹s each independently represent a monovalent organic group containing a C₁ to C₁₈ monovalent hydrocarbon group the hydrogen elements of which may partially or entirely be replaced with a fluorine element(s); X¹s each independently represent at least one group selected from the group consisting of monovalent functional groups in which an element to be bonded to the silicon element is nitrogen, monovalent functional groups in which an element to be bonded to the silicon element is oxygen, halogen groups, nitrile groups, and —CO—NH—Si(CH₃)₃ groups; a represents an integer of 1 to 3; b represents an integer of 0 to 2; and the total of a and b is 1 to 3.)

R¹ in the formula [1] reduces the surface energy of the protective film to thereby reduce the interaction, such as hydrogen bonds or intermolecular forces, between water or another liquid and the surface of the protective film (i.e., at the interface). The effect of reducing the interaction is particularly large for water, but it is also exhibited for a mixed liquid of water and a non-water liquid or for a non-water liquid. The reduction of the interaction can increase the contact angle between the surface of the article and the liquid.

X¹ in the formula [1] is a reactive moiety having reactivity with, for example, a silanol group serving as a reaction site of a silicon wafer. The reactive moiety reacts with a silanol group of a wafer, i.e., the silylation agent is chemically bonded to a silicon element of the silicon wafer through a siloxane bond, so that the protective film is formed. After cleaning of the silicon wafer with a cleaning liquid, if the protective film is formed on the surfaces of the recessed portions of the wafer at the time of removing or drying the cleaning liquid out of the recessed portions, the capillary force of the surfaces of the recessed portions decreases. Thus, pattern collapse is less likely to occur.

The monovalent functional group in which an element to be bonded to a silicon element is nitrogen, which is one example of X¹ in the formula [1], may include not only hydrogen, carbon, nitrogen, and oxygen but also an element such as silicon, sulfur, or halogen. Examples of the functional group include an isocyanate group, an amino group, a dialkylamino group, an isothiocyanate group, an azide group, an acetamide group, —N(CH₃)C(O)CH₃, —N(CH₃)C(O)CF₃, —N═C(CH₃)OSi(CH₃)₃, —N═C(CF₃)OSi(CH₃)₃, —NHC(O)—OSi(CH₃)₃, —NHC(O)—NH—Si(CH₃)₃, an imidazole ring (the following formula [7]), an oxazolidinone ring (the following formula [8]), a morpholine ring (the following formula [9]), —NH—C(O)—Si(CH₃)₃, and —N(H)₂₋ₕ(Si(H)ᵢR⁹₃₋ᵢ)ₕ (wherein R⁹ represents a C₁ to C₁₈ monovalent hydrocarbon group the hydrogen elements of which may partially or entirely be replaced with a fluorine element (s); h represents 1 or 2; and i represents an integer of 0 to 2).

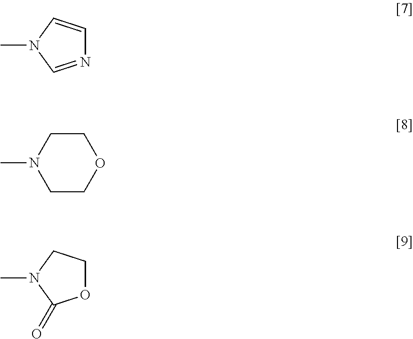

The monovalent functional group in which an element to be bonded to a silicon element is oxygen, which is one example of X¹ in the formula [1], may include not only hydrogen, carbon, nitrogen, and oxygen but also an element such as silicon, sulfur, or halogen. Examples of the functional group include an alkoxy group, a —OC(CH₃)═CHCOCH₃ group, a —OC(CH₃)═N—Si(CH₃)₃ group, a —OC(CF₃)═N—Si(CH₃)₃ group, a —O—CO—R¹⁰ group (wherein R¹⁰ represents a C₁ to C₁₈ monovalent hydrocarbon group the hydrogen elements of which may partially or entirely be replaced with a fluorine element(s)), and an alkyl sulfonate group the hydrogen elements of which may partially or entirely be replaced with a fluorine element(s).

Examples of the halogen group, which is one example of X¹ in the formula [1], include a chloro group, a bromo group, and an iodo group.

Examples of the silylation agent represented by the formula [1] include: alkylmethoxysilanes such as CH₃Si(OCH₃)₃, C₂H₅Si(OCH₃)₃, C₃H₇Si(OCH₃)₃, C₄H₉Si(OCH₃)₃, C₅H₁₁Si(OCH₃)₃, C₆H₁₃Si(OCH₃)₃, C₇H₁₅Si(OCH₃)₃, C₈H₁₇Si(OCH₃)₃, C₉H₁₉Si(OCH₃)₃, C₁₀H₂₁Si(OCH₃)₃, C₁₁H₂₃Si(OCH₃)₃, C₁₂H₂₅Si(OCH₃)₃, C₁₃H₂₇Si(OCH₃)₃, C₁₄H₂₉Si(OCH₃)₃, C₁₅H₃₁Si(OCH₃)₃, C₁₆H₃₃Si(OCH₃)₃, C₁₇H₃₅Si(OCH₃)₃, C₁₈H₃₇Si(OCH₃)₃, (CH₃)₂Si(OCH₃)₂, C₂H₅Si(CH₃)(OCH₃)₂, (C₂H₅)₂Si(OCH₃)₂, C₃H₇Si(CH₃)(OCH₃)₂, (C₃H₇)₂Si(OCH₃)₂, C₄H₉Si(CH₃)(OCH₃)₂, (C₄H₉)₂Si(OCH₃)₂, C₅H₁₁Si(CH₃)(OCH₃)₂, C₆H₁₃Si(CH₃)₂, (OCH₃)₂, C₇H₁₅Si(CH₃)(OCH₃)₂, C₈H₁₇Si(CH₃)(OCH₃)₂, C₉H₁₉Si(CH₃)(OCH₃)₂, C₁₀H₂₁Si(CH₃)(OCH₃)₂, C₁₁H₂₃Si(CH₃)(OCH₃)₂, C₁₂H₂₅Si(CH₃)(OCH₃)₂, C₁₃H₂₇Si(CH₃)(OCH₃)₂, C₁₄H₂₉Si(CH₃)(OCH₃) C₁₅H₃₁Si(CH₃)(OCH₃)₂, C₁₆H₃₃Si(CH₃)(OCH₃)₂, C₁₇H₃₅Si(CH₃)(OCH₃)₂, C₁₈H₃₇Si(CH₃)(OCH₃)₂(CH₃)₃SiOCH₃, C₂H₅Si(CH₃)₂OCH₃, (C₂H₅)₂Si(CH₃) OCH₃(C₂H₅)₃SiOCH₃, C₃H₇Si(CH₃)₂OCH₃, (C₃H₇)₂Si(CH₃) OCH₃, (C₃H₇)₃SiOCH₃, C₄H₉Si(CH₃)₂OCH₃, (C₄H₉)₃SiOCH₃, C₅H₁₁Si(CH₃)₂OCH₃, C₆H₁₃Si(CH₃)₂OCH₃, C₇H₁₅Si(CH₃)₂OCH₃, C₅H₁₇Si(CH₃)₂OCH₃, C₉H₁₉Si(CH₃)₂OCH₃, C₁₀H₂₁Si(CH₃)₂OCH₃, C₁₁H₂₃Si(CH₃)₂OCH₃, C₁₂H₂₅Si(CH₃)₂OCH₃, C₁₃H₂₇Si(CH₃)₂OCH₃, C₁₄H₂₉Si(CH₃)₂OCH₃, C₁₅H₃₁Si(CH₃)₂OCH₃, C₁₆H₃₃Si(CH₃)₂OCH₃, C₁₇H₃₅Si(CH₃)₂OCH₃, C₁₈H₃₇Si(CH₃)₂OCH₃, (CH₃)₂Si(H)OCH₃, CH₃Si(H)₂OCH₃, (C₂H₅)₂Si(H)OCH₃, C₂H₅Si(H)₂OCH₃, C₂H₅Si(CH₃)(H)OCH₃, and (C₃H₇)₂Si(H)OCH₃; fluoroalkylmethoxysilanes such as CF₃CH₂CH₂Si(OCH₃)₃, C₂F₅CH₂CH₂Si(OCH₃)₃, C₃F₇CH₂CH₂Si(OCH₃)₃, C₄F₉CH₂CH₂Si(OCH₃)₃, C₅F₁₁CH₂CH₂Si(OCH₃)₃, C₆F₁₃CH₂CH₂Si(OCH₃)₃, C₇F₁₅CH₂CH₂Si(OCH₃)₃, C₈F₁₇CH₂CH₂Si(OCH₃)₃, CF₃CH₂CH₂Si(CH₃)(OCH₃)₂, C₂F₅CH₂CH₂Si(CH₃)(OCH₃)₂, C₃F₇CH₂CH₂Si(CH₃)(OCH₃)₂, C₄F₉CH₂CH₂Si(CH₃)(OCH₃)₂, C₅F₁₁CH₂CH₂Si(CH₃)(OCH₃)₂, C₆F₁₃CH₂CH₂Si(CH₃)(OCH₃)₂, C₇F₁₅CH₂CH₂Si(CH₃)(OCH₃)₂, C₈F₁₇CH₂CH₂Si(CH₃)(OCH₃)₂, CF₃CH₂CH₂Si(CH₃)₂OCH₃, C₂F₅CH₂CH₂Si(CH₃)₂OCH₃, C₃F₇CH₂CH₂Si(CH₃)₂OCH₃, C₄F₉CH₂CH₂Si(CH₃)₂OCH₃, C₅F₁₁CH₂CH₂Si(CH₃)₂OCH₃, C₆F₁₃CH₂CH₂Si(CH₃)₂OCH₃, C₇F₁₅CH₂CH₂Si(CH₃)₂OCH₃, C₈F₁₇CH₂CH₂Si(CH₃)₂OCH₃, and CF₃CH₂CH₂Si(CH₃)(H)OCH₃; alkoxysilane compounds obtained by substituting a methyl group moiety of the methoxy group of the above-mentioned alkylmethoxysilanes or fluoroalkylmethoxysilanes with a C₂ to C₁₈ monovalent hydrocarbon group; and compounds obtained by substituting the methoxy group with —OC(CH₃)═CHCOCH₃, —OC(CH₃)═N—Si(CH₃)₃, —OC(CF₃)═N—Si(CH₃)₃, —O—CO—R¹⁰ (wherein R¹⁰ represents a C₁ to C₁₈ monovalent hydrocarbon group the hydrogen elements of which may partially or entirely be replaced with a fluorine element(s)), an alkyl sulfonate group the hydrogen elements of which may partially or entirely be replaced with a fluorine element(s), an isocyanate group, an amino group, a dialkyl amino group, an isothiocyanate group, an azide group, an acetamide group, —N(CH₃)C(O)CH₃, —N(CH₃)C(O)CF₃, —N═C(CH₃)OSi(CH₃)₃, —N═C(CF₃)OSi(CH₃)₃, —NHC(O)—OSi(CH₃)₃, —NHC(O)—NH—Si(CH₃)₃, an imidazole ring, an oxazolidinone ring, a morpholine ring, —NH—C(O)—Si(CH₃)₃, —N(H)₂₋ₕ(Si(H)ᵢR⁹₃₋ᵢ)ₕ (wherein R⁹ represents a C₁ to C₁₈ monovalent hydrocarbon group the hydrogen elements of which may partially or entirely be replaced with a fluorine element(s); h represents 1 or 2; and i represents an integer of 0 to 2), a chloro group, a bromo group, an iodo group, a nitrile group, or —CO—NH—Si(CH₃)₃.

The number of X¹ of the silylation agent, which is represented by 4-a-b in the formula [1], is preferably 1 because the protective film is uniformly formed in this case.

R¹s in the formula [1] each independently represent preferably at least one selected from the group consisting of C₁ to C₁₈ monovalent hydrocarbon groups the hydrogen elements of which may partially or entirely be replaced with a fluorine element(s), or more preferably at least one selected from the group consisting of CₘH₂ₘ₊₁ (m=1 to 18) and CₙF₂ₙ₊₁CH₂CH₂ (n=1 to 8). In this case, when the protective film is formed on the surface of the uneven pattern, the wettability of the surface can be further reduced. In other words, better water repellency can be imparted to the surface. Preferably, m is 1 to 12, and n is 1 to 8 because the protective film can be formed on the surface of the uneven pattern in a short time in this case.

The acid in the liquid chemical is preferably at least one selected from the group consisting of hydrogen chloride, sulfuric acid, perchloric acid, sulfonic acid represented by the formula [2] below and its anhydride, carboxylic acid represented by the formula [3] below and its anhydride, alkyl borate ester, aryl borate ester, boron tris(trifluoroacetate), trialkoxyboroxin, boron trifluoride, and silane compounds represented by the formula [4] below.

R²S(O)₂OH [2]

(In the formula [2], R² represents a C₁ to C₁₈ monovalent hydrocarbon group the hydrogen elements of which may partially or entirely be replaced with a fluorine element(s).)

R³COOH [3]

(In the formula [3], R³ represents a C₁ to C₁₈ monovalent hydrocarbon group the hydrogen elements of which may partially or entirely be replaced with a fluorine element(s).)

(R⁴)_{c}Si(H)_{d}X²_{4-c-d} [4]

(In the formula [4], R⁴s each independently represent a C₁ to C₁₈ monovalent hydrocarbon group the hydrogen elements of which may partially or entirely be replaced with a fluorine element(s); X²s each independently represent at least one selected from the group consisting of a chloro group, —OCO—R⁵ (wherein R⁵ represents a C₁ to C₁₈ monovalent hydrocarbon group the hydrogen elements of which may partially or entirely be replaced with a fluorine element(s)), and —OS(O)₂—R⁶ (wherein R⁶ represents a C₁ to C₁₈ monovalent hydrocarbon group the hydrogen elements of which may partially or entirely be replaced with a fluorine element(s)); c represents an integer of 1 to 3; d represents an integer of 0 to 2; and the total of c and d is 1 to 3.)

Examples of the sulfonic acid represented by the formula [2] and its anhydride include methanesulfonic acid, benzenesulfonic acid, p-toluenesulfonic acid, trifluoromethanesulfonic acid, and trifluoromethanesulfonic anhydride. Examples of the carboxylic acid represented by the formula [3] and its anhydride include acetic acid, trifluoroacetic acid, pentafluoropropionic acid, acetic anhydride, trifluoroacetic anhydride, and pentafluoropropionic anhydride. Preferable examples of the silane compound represented by the formula [4] include chlorosilanes, alkyl silyl alkyl sulfonates, and alkyl silyl esters. Other examples of the silane compound include trimethylsilyl trifluoroacetate, trimethylsilyl trifluoromethanesulfonate, dimethylsilyl trifluoroacetate, dimethylsilyl trifluoromethanesulfonate, butyldimethylsilyl trifluoroacetate, butyldimethylsilyl trifluoromethanesulfonate, hexyldimethylsilyl trifluoroacetate, hexyldimethylsilyl trifluoromethanesulfonate, octyldimethylsilyl trifluoroacetate, octyldimethylsilyl trifluoromethanesulfonate, decyldimethylsilyl trifluoroacetate, and decyldimethylsilyl trifluoromethanesulfonate.

The base in the liquid chemical is preferably at least one selected from the group consisting of ammonia, N,N,N′,N′-tetramethylethylenediamine, triethylenediamine, dimethylaniline, alkylamine, dialkylamine, trialkylamine, pyridine, piperazine, N-alkylmorpholine, and silane compounds represented by the following formula [5].

(R⁷)ₑSi(H)_{f}X³_{4-e-f} [5]

(In the formula [5], R⁷s each independently represent a C₁ to C₁₈ monovalent hydrocarbon group the hydrogen elements of which may partially or entirely be replaced with a fluorine element(s); X³s each independently represent a monovalent functional group optionally containing a fluorine element or a silicon element, in which an element to be bonded to the silicon element is nitrogen; e is an integer of 1 to 3; f is an integer of 0 to 2; and the total of e and f is 1 to 3.)

The acid or base in the liquid chemical accelerates the reaction between the silylation agent and, for example, a silanol group serving as a reaction site of the surface of the uneven pattern of the silicon wafer. Thus, excellent water repellency can be imparted to the surface of the wafer treated with the liquid chemical. The acid or base may partially form the protective film.

Considering the reaction-accelerating effect, the liquid chemical preferably contains an acid. Particularly preferable examples of the acid include: a strong Bronsted acid such as hydrogen chloride and perchloric acid; an alkane sulfonic acid the hydrogen elements of which are partially or entirely replaced with a fluorine element(s) or its anhydride, such as trifluoromethanesulfonic acid and trifluoromethanesulfonic anhydride; carboxylic acid the hydrogen elements of which are partially or entirely replaced with a fluorine element(s) or its acid anhydride, such as trifluoroacetic acid, trifluoroacetic anhydride, and pentafluoropropionic acid; chlorosilane; alkyl silyl alkyl sulfonate the hydrogen elements of which are partially or entirely replaced with a fluorine element(s); and alkyl silyl ester the hydrogen elements of which are partially or entirely replaced with a fluorine element(s). The alkyl silyl ester is formed such that an alkyl group and a —O—CO—R′ group (wherein R′ is an alkyl group) are bonded to a silicon element. The acid in the liquid chemical may be formed by a reaction. For example, the protective film-forming liquid chemical may be formed by reacting alkylchlorosilane with alcohol, and using the alkylalkoxysilane produced, the hydrochloric acid produced, and alcohol not consumed in the reaction as a silylation agent, an acid, and a nonaqueous organic solvent, respectively.

The protective film-forming liquid chemical is preferably a liquid chemical containing a mixture of 76 to 99.8999% by mass of at least one kind of nonaqueous organic solvent selected from the group consisting of hydrofluoroethers, hydrochlorofluorocarbons, polyalcohol derivatives having no OH group, and lactone-based solvents, 0.1 to 20% by mass of at least one kind of silylation agent selected from the group consisting of alkoxylsilane having a CₓH₂ₓ₊₁ group (x=1 to 12) or a C_{y}F_{2y+1}CH₂CH₂ group (y=1 to 8), trimethyldimethylaminosilane, trimethyldiethylaminosilane, butyldimethyl(dimethylamino)silane, butyldimethyl(diethylamino)silane, hexyldimethyl(dimethylamino)silane, hexyldimethyl(diethylamino)silane, octyldimethyl(dimethylamino)silane, octyldimethyl(diethylamino)silane, decyldimethyl(dimethylamino)silane, decyldimethyl(diethylamino)silane, dodecyldimethyl(dimethylamino)silane, and dodecyldimethyl(diethylamino)silane, and 0.0001 to 4% by mass of at least one kind of acid selected from the group consisting of trifluoroacetic acid, trifluoroacetic anhydride, trifluoromethanesulfonic acid, trifluoromethanesulfonic anhydride, trimethylsilyl trifluoroacetate, trimethylsilyl trifluoromethanesulfonate, dimethylsilyl trifluoroacetate, dimethylsilyl trifluoromethanesulfonate, butyldimethylsilyl trifluoroacetate, butyldimethylsilyl trifluoromethanesulfonate, hexyldimethylsilyl trifluoroacetate, hexyldimethylsilyl trifluoromethanesulfonate, octyldimethylsilyl trifluoroacetate, octyldimethylsilyl trifluoromethanesulfonate, decyldimethylsilyl trifluoroacetate, and decyldimethylsilyl trifluoromethanesulfonate; or a liquid chemical consisting only of the mixture.

Also, the protective film-forming liquid chemical is preferably a liquid chemical containing a mixture of 76 to 99.8999% by mass of at least one kind of nonaqueous organic solvent selected from the group consisting of hydrofluoroethers, hydrochlorofluorocarbons, and polyalcohol derivatives having no OH group, 0.1 to 20% by mass of at least one kind of silylation agent selected from the group consisting of hexamethyldisilazane, tetramethyldisilazane, 1,3-dibutyltetramethyldisilazane, 1,3-dihexyltetramethyldisilazane, 1,3-dioctyltetramethyldisilazane, 1,3-didecyltetramethyldisilazane, and 1,3-didodecyltetramethyldisilazane, and 0.0001 to 4% by mass of at least one kind of acid selected from the group consisting of trifluoroacetic acid, trifluoroacetic anhydride, trifluoromethanesulfonic acid, trifluoromethanesulfonic anhydride, trimethylsilyl trifluoroacetate, trimethylsilyl trifluoromethanesulfonate, dimethylsilyl trifluoroacetate, dimethylsilyl trifluoromethanesulfonate, butyldimethylsilyl trifluoroacetate, butyldimethylsilyl trifluoromethanesulfonate, hexyldimethylsilyl trifluoroacetate, hexyldimethylsilyl trifluoromethanesulfonate, octyldimethylsilyl trifluoroacetate, octyldimethylsilyl trifluoromethanesulfonate, decyldimethylsilyl trifluoroacetate, and decyldimethylsilyl trifluoromethanesulfonate; or a liquid chemical consisting only of the mixture.

In the case where the protective film-forming liquid chemical is stored in the pressure feed container of the present invention, in order to maintain the performance of the liquid chemical, the rate of decrease in the concentration of the silylation agent in the liquid chemical after a high-temperature storage test relative to the concentration of the silylation agent before the test is preferably not more than 80%, more preferably not more than 50%, and still more preferably not more than 10%. The high-temperature storage test is performed by storing the liquid chemical at 45° C. for 12 months.

The same nonaqueous organic solvents as those usable in the liquid chemical may be mentioned as the nonaqueous organic solvent to be used in the treatment liquid A or treatment liquid B.

The silylation agent in the treatment liquid A is preferably at least one selected from the group consisting of the silicon compounds represented by the formula [1].

Moreover, the silylation agent in the treatment liquid A is preferably the silicon compound represented by the following formula [6].

R⁸_{g}SiX⁴_{4-g} [6]

(In the formula [6], R⁸s each independently represent at least one selected from a hydrogen group and a C₁ to C₁₈ monovalent hydrocarbon group the hydrogen elements of which may partially or entirely be replaced with a fluorine element(s), in which the total number of carbons contained in all of the hydrocarbon groups bonded to the silicon element is not smaller than 6; X⁴s each independently represent at least one selected from a monovalent functional group the element of which to be bonded to the silicon element is nitrogen, a monovalent functional group the element of which to be bonded to the silicon element is oxygen, a halogen group, a nitrile group, and —CO—NH—Si(CH₃)₃; and g is an integer of 1 to 3.)

R⁸ in the formula [6] reduces the surface energy of the protective film to thereby reduce the interaction, such as hydrogen bonds or intermolecular forces, between water or another liquid and the surface of the protective film (i.e., at the interface). The effect of reducing the interaction is particularly large for water, but it is also exhibited for a mixed liquid of water and a non-water liquid or for a non-water liquid. The reduction of the interaction can increase the contact angle between the surface of the protective film and the liquid. R⁸ behaves as a hydrophobic group. If the protective film is formed by use of a bulky hydrophobic group, the surface of the wafer after treatment exhibits good water repellency. When the total number of carbons contained in all of the hydrocarbon groups that serve as R⁸ and are bonded to the silicon element is not smaller than 6, a water repellent film capable of exhibiting sufficient water repellent performance can be produced even if the number of OH groups per unit area of the uneven pattern of the wafer containing silicon element is small.

X⁴ in the formula [6] is a reactive moiety having reactivity with, for example, a silanol group serving as a reaction site of a silicon wafer. The reactive moiety reacts with a silanol group of a wafer, i.e., the silylation agent is chemically bonded to a silicon element of the silicon wafer through a siloxane bond, so that the protective film is formed. After cleaning of the silicon wafer with a cleaning liquid, if the protective film is formed on the surfaces of the recessed portions of the wafer at the time of removing or drying the cleaning liquid out of the recessed portions, the capillary force of the surfaces of the recessed portions decreases. Thus, pattern collapse is less likely to occur.

Examples of the silicon compound represented by the formula [6] include chlorosilane-based compounds such as C₄H₉(CH₃)₂SiCl, C₅H₁₁(CH₃)₂SiCl, C₆H₁₃(CH₃)₂SiCl, C₇H₁₅(CH₃)₂SiCl, C₈H₁₇(CH₃)₂SiCl, C₉H₁₉(CH₃)₂SiCl, C₁₀H₂₁(CH₃)₂SiCl, C₁₁H₂₃(CH₃)₂SiCl, C₁₂H₂₅(CH₃)₂SiCl, C₁₃H₂₇(CH₃)₂SiCl, C₁₄H₂₉(CH₃)₂SiCl, C₁₅H₃₁(CH₃)₂SiCl, C₁₆H₃₃(CH₃)₂SiCl, C₁₇H₃₅(CH₃)₂SiCl, C₁₈H₃₇(CH₃)₂SiCl, C₅H₁₁(CH₃)HSiCl, C₆H₁₃(CH₃)HSiCl, C₇H₁₅(CH₃)HSiCl, C₈H₁₇(CH₃)HSiCl, C₉H₁₉(CH₃)HSiCl, C₁₀H₂₁(CH₃)HSiCl, C₁₁H₂₃(CH₃)HSiCl, C₁₂H₂₅(CH₃)HSiCl, C₁₃H₂₇(CH₃)HSiCl, C₁₄H₂₉(CH₃)HSiCl, C₁₅H₃₁(CH₃)HSiCl, C₁₆H₃₃(CH₃)HSiCl, C₁₇H₃₅(CH₃)HSiCl, C₁₈H₃₇(CH₃)HSiCl, C₂F₅C₂H₄(CH₃)₂SiCl, C₃F₇C₂H₄(CH₃)₂SiCl, C₄F₉C₂H₄(CH₃)₂SiCl, C₅F₁₁C₂H₄(CH₃)₂SiCl, C₆F₁₃C₂H₄(CH₃)₂SiCl, C₇F₁₅C₂H₄(CH₃)₂SiCl, C₈F₁₇C₂H₄(CH₃)₂SiCl, (C₂H₅)₃SiCl, C₃H₇(C₂H₅)₂SiCl, C₄H₉(C₂H₅)₂SiCl, C₅H₁₁(C₂H₅)₂SiCl, C₆H₁₃(C₂H₅)₂SiCl, C₇H₁₅(C₂H₅)₂SiCl, C₈H₁₇(C₂H₅)₂SiCl, C₉H₁₉(C₂H₅)₂SiCl, C₁₀X₂₁(C₂H₅)₂SiCl, C₁₁H₂₃(C₂H₅)₂SiCl, C₁₂H₂₅(C₂H₅)₂SiCl, C₁₃H₂₇(C₂H₅)₂SiCl, C₁₄H₂₉(C₂H₅)₂SiCl, C₁₅H₃₁(C₂H₅)₂SiCl, C₁₆H₃₃(C₂H₅)₂SiCl, C₁₇H₃₅(C₂H₅)₂SiCl, C₁₈H₃₇(C₂H₅)₂SiCl, (C₄H₉)₃SiCl, C₅H₁₁(C₄H₉)₂SiCl, C₆H₁₃(C₄H₉)₂SiCl, C₇H₁₅(C₄H₉)₂SiCl, C₈H₁₇(C₄H₉)₂SiCl, C₉H₁₉(C₄H₉)₂SiCl, C₁₀H₂₁(C₄H₉)₂SiCl, C₁₁H₂₃(C₄H₉)₂SiCl, C₁₂H₂₅(C₄H₉)₂SiCl, C₁₃H₂₇(C₄H₉)₂SiCl, C₁₄H₂₉(C₄H₉)₂SiCl, C₁₅H₃₁(C₄H₉)₂SiCl, C₁₆H₃₃(C₄H₉)₂SiCl, C₁₇H₃₅(C₄H₉)₂SiCl, C₁₈H₃₇(C₄H₉)₂SiCl, CF₃C₂H₄(C₄H₉)₂SiCl, C₂F₅C₂H₄(C₄H₉)₂SiCl, C₃F₇C₂H₄(C₄H₉)₂SiCl, C₄F₉C₂H₄(C₄H₉)₂SiCl, C₅F₁₁C₂H₄(C₄H₉)₂SiCl, C₆F₁₃C₂H₄(C₄H₉)₂SiCl, C₇F₁₅C₂H₄(C₄H₉)₂SiCl, C₈F₁₇C₂H₄(C₄H₉)₂SiCl, C₅H₁₁(CH₃)SiCl₂, C₆H₁₃(CH₃)SiCl₂, C₇H₁₅(CH₃)SiCl₂, C₈H₁₇(CH₃)SiCl₂, C₉H₁₉(CH₃)SiCl₂, C₁₀H₂₁(CH₃)SiCl₂, C₁₁H₂₃(CH₃)SiCl₂, C₁₂H₂₅(CH₃)SiCl₂, C₁₃H₂₇(CH₃)SiCl₂, C₁₄H₂₉(CH₃)SiCl₂, C₁₅H₃₁(CH₃)SiCl₂, C₁₆H₃₃(CH₃)SiCl₂, C₁₇H₃₅(CH₃)SiCl₂, C₁₅H₃₇(CH₃)SiCl₂, C₃F₇C₂H₄(CH₃)SiCl₂, C₄F₉C₂H₄(CH₃)SiCl₂, C₅F₁₁C₂H₄(CH₃)SiCl₂, C₆F₁₃C₂H₄(CH₃)SiCl₂, C₇F₁₅C₂H₄(CH₃)SiCl₂, C₈F₁₇C₂H₄(CH₃)SiCl₂, C₆H₁₃SiCl₃, C₇H₁₅SiCl₃x, C₈H₁₇SiCl₃, C₉H₁₉SiCl₃, C₁₀H₂₁SiCl₃, C₁₁H₂₃SiCl₃, C₁₂H₂₅SiCl₃, C₁₃H₂₇SiCl₃, C₁₄H₂₉SiCl₃, C₁₅H₃₁SiCl₃, C₁₆H₃₃SiCl₃, C₁₇H₃₅SiCl₃, C₁₈H₃₇SiCl₃, C₄F₉C₂H₄SiCl₃, C₅F₁₁C₂H₄SiCl₃, C₆F₁₃C₂H₄SiCl₃, C₇F₁₅C₂H₄SiCl₃, and C₈F₁₇C₂H₄SiCl₃; and compounds obtained by substituting the chloro (Cl) group of the above-mentioned chlorosilanes with an alkoxy group, —OC(CH₃)═CHCOCH₃, —OC(CH₃)—N—Si(CH₃)₃, —OC(CF₃)—N—Si(CH₃)₃, —O—CO—R¹⁰ (wherein R¹⁰ represents a C₁ to C₁₈ monovalent hydrocarbon group the hydrogen elements of which may partially or entirely be replaced with a fluorine element(s)), an alkyl sulfonate group the hydrogen elements of which may partially or entirely be replaced with a fluorine element(s), an isocyanate group, an amino group, a dialkyl amino group, an isothiocyanate group, an azide group, an acetamide group, —N(CH₃)C(O)CH₃, —N(CH₃)C(O)CF₃, —N═C(CH₃)OSi(CH₃)₃, —N═C(CF₃)OSi(CH₃)₃, —NHC(O)—OSi(CH₃)₃, —NHC(O)—NH—Si(CH₃)₃, an imidazole ring, an oxazolidinone ring, a morpholine ring, —NH—C(O)—Si(CH₃)₃, —N(H)₂₋ₕ(Si(H)ᵢR⁹₃₋ᵢ)ₕ (wherein R⁹ represents a C₁ to C₁₈ monovalent hydrocarbon group the hydrogen elements of which may partially or entirely be replaced with a fluorine element(s); h represents an integer of 1 or 2; and i represents an integer of 0 to 2), a bromo group, an iodo group, a nitrile group, or —CO—NH—Si(CH₃)₃.

Moreover, g in the formula [6] being an integer of 1 to 3 is sufficient. However, if g is 1 or 2, storing a liquid chemical prepared from the liquid chemical kit for a long time may cause polymerization of the silicon compound due to mixing of moisture. Thus, the storable period may decrease. Considering the above, g in the formula [6] is preferably 3.

The silicon compound represented by the formula [6] is preferably one in which one of R⁸s is a C₄ to C₁₈ monovalent hydrocarbon group the hydrogen elements of which may partially or entirely be replaced with a fluorine element(s), and the other R⁸s each consists of two methyl groups as such a compound enables a faster reaction with OH groups on the surface of the uneven pattern or on the surface of the wafer. This is because steric hindrance due to the hydrophobic group has a great influence on the reaction rate, and because an alkyl chain to be bonded to a silicon element preferably has the longest chain and two other shorter chains, in a reaction between the silicon compound and the OH group on the surface of the uneven pattern or on the surface of the wafer.

The same acids as those usable in the liquid chemical may be mentioned as the acid to be used in the treatment liquid B.

The same bases as those usable in the liquid chemical may be mentioned as the base to be used in the treatment liquid B.

In the water-repellent protective film-forming liquid chemical prepared by mixing the liquid chemical kit, the acid or base in the treatment liquid B accelerates the reaction between the silylation agent and, for example, a silanol group serving as a reaction site of the surface of the uneven pattern of the silicon wafer. Thus, excellent water repellency can be imparted to the surface of the wafer treated with the liquid chemical. The acid or base may partially form the protective film.

Considering the reaction-accelerating effect, the treatment liquid B preferably contains an acid. Particularly preferable examples of the acid include: a strong Bronsted acid such as hydrogen chloride and perchloric acid; an alkane sulfonic acid the hydrogen elements of which are partially or entirely replaced with a fluorine element(s) or its anhydride, such as trifluoromethanesulfonic acid, and trifluoromethanesulfonic anhydride; carboxylic acid the hydrogen elements of which are partially or entirely replaced with a fluorine element(s) or its acid anhydride, such as trifluoroacetic acid, trifluoroacetic anhydride, and pentafluoropropionic acid; chlorosilane; alkyl silyl alkyl sulfonate the hydrogen elements of which are partially or entirely replaced with a fluorine element(s); and alkyl silyl ester the hydrogen elements of which are partially or entirely replaced with a fluorine element(s).

The treatment liquid A for the protective film-forming liquid chemical kit is preferably, for example, a treatment liquid containing a mixture of 60 to 99.8% by mass of at least one kind of nonaqueous organic solvent selected from the group consisting of hydrofluoroethers, hydrochlorofluorocarbons, polyalcohol derivatives having no OH group, and lactone-based solvents, and 0.2 to 40% by mass of at least one kind of silylation agent selected from the group consisting of alkoxysilanes having a CₓH₂ₓ₊₁ group (x=1 to 10) or a C_{y}F_{2y+1}CH₂CH₂ group (y=1 to 8), trimethyldimethylaminosilane, trimethyldiethylaminosilane, butyldimethyl(dimethylamino)silane, butyldimethyl(diethylamino)silane, hexyldimethyl(dimethylamino)silane, hexyldimethyl(diethylamino)silane, octyldimethyl(dimethylamino)silane, octyldimethyl(diethylamino)silane, decyldimethyl(dimethylamino)silane, decyldimethyl(diethylamino)silane, dodecyldimethyl(dimethylamino)silane, and dodecyldimethyl(diethylamino)silane; or a treatment liquid consisting only of the mixture. The treatment liquid B for the protective film-forming liquid chemical kit is preferably, for example, a treatment liquid containing a mixture of 60 to 99.9998% by mass of at least one kind of nonaqueous organic solvent selected from the group consisting of hydrofluoroethers, hydrochlorofluorocarbons, polyalcohol derivatives having no OH group, and lactone-based solvents, and 0.0002 to 40% by mass of at least one kind of acid selected from the group consisting of trifluoroacetic acid, trifluoroacetic anhydride, trifluoromethanesulfonic acid, trifluoromethanesulfonic anhydride, trimethylsilyl trifluoroacetate, trimethylsilyl trifluoromethanesulfonate, dimethylsilyl trifluoroacetate, dimethylsilyl trifluoromethanesulfonate, butyldimethylsilyl trifluoroacetate, butyldimethylsilyl trifluoromethanesulfonate, hexyldimethylsilyl trifluoroacetate, hexyldimethylsilyl trifluoromethanesulfonate, octyldimethylsilyl trifluoroacetate, octyldimethylsilyl trifluoromethanesulfonate, decyldimethylsilyl trifluoroacetate, and decyldimethylsilyl trifluoromethanesulfonate; or a treatment liquid consisting only of the mixture. The water-repellent protective film-forming liquid chemical is prepared by mixing the treatment liquid A and the treatment liquid B preferably in such a manner that a prepared liquid chemical includes 76 to 99.8999% by mass of the nonaqueous organic solvent, 0.1 to 20% by mass of the silylation agent, and 0.0001 to 4% by mass of the acid based on 100% by mass of the liquid chemical.

The treatment liquid A for the protective film-forming liquid chemical kit is preferably, for example, a treatment liquid containing a mixture of 60 to 99.8% by mass of at least one kind of nonaqueous organic solvent selected from the group consisting of hydrofluoroethers, hydrochlorofluorocarbons, and polyalcohol derivatives having no OH group, and 0.2 to 40% by mass of at least one kind of silylation agent selected from the group consisting of hexamethyldisilazane, tetramethyl disilazane, 1,3-dibutyl tetramethyl disilazane, 1,3-dihexyl tetramethyl disilazane, 1,3-dioctyl tetramethyl disilazane, 1,3-didecyl tetramethyl disilazane, and 1,3-didodecyl tetramethyl disilazane; or a treatment liquid consisting only of the mixture. The treatment liquid B for the protective film-forming liquid chemical kit is preferably, for example, a treatment liquid containing a mixture of 60 to 99.9998% by mass of at least one kind of nonaqueous organic solvent selected from the group consisting of hydrofluoroethers, hydrochlorofluorocarbons, and polyalcohol derivatives having no OH group, and 0.0002 to 40% by mass of at least one kind of acid selected from the group consisting of trifluoroacetic acid, trifluoroacetic anhydride, trifluoromethanesulfonic acid, trifluoromethanesulfonic anhydride, trimethylsilyl trifluoroacetate, trimethylsilyl trifluoromethanesulfonate, dimethylsilyl trifluoroacetate, dimethylsilyl trifluoromethanesulfonate, butyldimethylsilyl trifluoroacetate, butyldimethylsilyl trifluoromethanesulfonate, hexyldimethylsilyl trifluoroacetate, hexyldimethylsilyl trifluoromethanesulfonate, octyldimethylsilyl trifluoroacetate, octyldimethylsilyl trifluoromethanesulfonate, decyldimethylsilyl trifluoroacetate, and decyldimethylsilyl trifluoromethanesulfonate; or a treatment liquid consisting only of the mixture. The water-repellent protective film-forming liquid chemical is prepared by mixing the treatment liquid A and the treatment liquid B preferably in such a manner that a prepared liquid chemical includes 76 to 99.89990 by mass of the nonaqueous organic solvent, 0.1 to 20% by mass of the silylation agent, and 0.0001 to 4% by mass of the acid based on 100% by mass of the liquid chemical.

In the case where the treatment liquid A is stored in the pressure feed container of the present invention, in order to maintain the performance of the liquid, the rate of decrease in the concentration of the silylation agent in the treatment liquid A after a high-temperature storage test relative to the concentration of the silylation agent before the test is preferably not more than 80%, more preferably not more than 50%, and still more preferably not more than 10%. The high-temperature storage test is performed by storing the treatment liquid A at 45° C. for 12 months.

In the case where the treatment liquid B is stored in the pressure feed container of the present invention, in order to maintain the performance of the liquid, the rate of decrease in the concentration of the acid or base in the treatment liquid B after a high-temperature storage test relative to the concentration of the acid or base before the test is preferably not more than 80%, more preferably not more than 50%, and still more preferably not more than 10%. The high-temperature storage test is performed by storing the treatment liquid B at 45° C. for 12 months.

A wafer having an uneven pattern on its surface is obtained mostly by the following procedures. First, a resist is applied to a smooth wafer surface. Then, the resist is exposed through a resist mask, followed by etching removal on the exposed resist or the unexposed resist to thereby produce a resist having a desired uneven pattern. A resist having an uneven pattern can also be obtained by pressing a mold having a pattern onto a resist. Then, the wafer is subjected to etching. At this time, the wafer surface corresponding to the recessed portions of the resist pattern is etched selectively. Finally, the resist is peeled off to thereby give a wafer having an uneven pattern.

Examples of a wafer having an uneven pattern on its surface and containing a silicon element at least at a part of the uneven pattern includes: those having a film containing silicon (e.g., silicon, silicon oxide, silicon nitride) formed on their surfaces; and those provided with, when an uneven pattern is formed thereon, a silicon element (e.g., silicon, silicon oxide, silicon nitride) on at least part of the surface of the uneven pattern.

In the case of a wafer consisting of a plurality of components including at least one selected from silicon, silicon oxide, and silicon nitride, a protective film may be formed on surfaces of at least one of silicon, silicon oxide, and silicon nitride. Examples of the wafer consisting of a plurality of components include: those provided with at least one of silicon, silicon oxide, and silicon nitride formed on their surfaces; and those having, when an uneven pattern is formed thereon, the uneven pattern consisting partly of at least one of silicon, silicon oxide, and silicon nitride. Meanwhile, the portion on which a protective film formed from the liquid chemical can be formed is the surfaces of silicon element-containing parts in the uneven pattern.

In the case where the protective film formed from the protective film-forming liquid chemical is formed at least on surfaces of the recessed portions of the uneven pattern of the wafer, assuming that water is retained on the surface, preferably a contact angle θ₁ (a contact angle in the case of using a liquid chemical stored for a predetermined period of time after preparation) is not reduced by 15° or more from a contact angle θ₀ (a contact angle in the case of using a liquid chemical within 10 minutes after preparation). In other words, preferably an inequality: θ₀-θ₁<15° is satisfied. If the reduction of the contact angle is 15° or more, the water repellent performance of the protective film is not stably exhibited. Thus, an improving effect for the cleaning step, in which pattern collapse is easily induced, may not be sufficiently maintained (i.e., the pot life is not good). Preferably, both the contact angle θ₀ and the contact angle θ₁ are from 50 to 130° because pattern collapse rarely occurs in this case. The closer to 90° the contact angles are, the smaller capillary force acts on the recessed portions, and thereby the further less likely the pattern collapse occurs. Thus, the contact angles are particularly preferably from 60 to 120°, and further more preferably from 70 to 110°.

The water repellent protective film is formed on the surfaces of the recessed portions of the wafer as follows: a reactive moiety of a silylation agent contained in the liquid chemical or the liquid chemical obtained from the liquid chemical kit reacts with a silanol group serving as a reaction site of the wafer, i.e., the silylation agent is chemically bonded to a silicon element of the silicon wafer or the like through a siloxane bond. The reactive moiety may be decomposed or modified by water so that the reactivity may decrease. Thus, the contact between the silicon compound and water needs to be reduced.

The liquid chemical or the liquid chemical prepared by mixing the liquid chemical kit can impart sufficient water repellency to the surfaces of the recessed portions of the wafer when it contains the silylation agent in an amount of 0.1 to 50% by mass based on 100% by mass of the liquid chemical. Surely, sufficient water repellency can be imparted to the recessed portions of the wafer even if the concentration of the silylation agent exceeds 50% by mass; however, the concentration of the silylation agent is preferably 0.1 to 50% by mass in view of cost. Hence, in order to ease the reduction in the reactivity of the reactive moiety of the silicon compound, it is important to lower the water content of the nonaqueous organic solvent serving as a primary component except for the silicon compound among the components contained in the liquid chemical.

The liquid chemical and the liquid chemical kit of the present invention may contain other additives or the like within a range not impairing the purpose of the present invention. Examples of the additives include oxidizing agents such as hydrogen peroxide and ozone, and surfactants. If a part of the uneven pattern of the wafer is formed from a material on which the protective film cannot be formed by use of the silicon compound, an additive which enables formation of the protective film on the material may be added. Moreover, other acids or bases may also be added for purposes other than catalytic effect.

### [Storage Method]

The following describes the storage method of the present invention. The storage method of the present invention is a method for storing a protective film-forming liquid chemical or a protective film-forming liquid chemical kit that is mixed into the protective film-forming liquid chemical in a pressure feed container, the protective film-forming liquid chemical being for forming a water-repellent protective film on at least surfaces of recessed portions of an uneven pattern formed on a surface of a wafer containing a silicon element at least at a part of the uneven pattern. The pressure feed container used in the storage method of the present invention is the aforementioned pressure feed container of the present invention, and thus detailed description thereof is omitted.

The protective film-forming liquid chemical includes a nonaqueous organic solvent, a silylation agent, and an acid or a base. The protective film-forming liquid chemical kit includes a treatment liquid A containing a nonaqueous organic solvent and a silylation agent, and a treatment liquid B containing a nonaqueous organic solvent and an acid or a base. The protective film-forming liquid chemical, treatment liquid A, and treatment liquid B stored by the storage method of the present invention are respectively the same as the protective film-forming liquid chemical, treatment liquid A, and treatment liquid B stored in the pressure feed container of the present invention, and thus detailed descriptions thereof are omitted.

In the storage method of the present invention, a liquid selected from the protective film-forming liquid chemical, the treatment liquid A, and the treatment liquid B is introduced into the pressure feed container of the present invention while applying pressure to the pressure feed container with an inert gas such that the pressure feed container has an internal pressure of 0.01 to 0.19 MPa in gauge pressure at 45° C. The inert gas is preferably nitrogen gas. The internal pressure at 45° C. is preferably 0.01 to 0.19 MPa in gauge pressure, and more preferably 0.03 to 0.1 MPa in gauge pressure.

In the storage method of the present invention, the liquid is stored at 0 to 45° C., and preferably at 10 to 35° C.

### [Method for Transferring a Liquid]

The following describes the method for transferring a liquid of the present invention. The method for transferring a liquid of the present invention is a method for transferring a protective film-forming liquid chemical or a protective film-forming liquid chemical kit that is mixed into the protective film-forming liquid chemical by using a pressure feed container configured to transfer a liquid upon application of pressure to the inside, the protective film-forming liquid chemical being for forming a water-repellent protective film on at least surfaces of recessed portions of an uneven pattern formed on a surface of a wafer containing a silicon element at least at a part of the uneven pattern.

The protective film-forming liquid chemical includes a nonaqueous organic solvent, a silylation agent, and an acid or a base. The protective film-forming liquid chemical kit includes a treatment liquid A containing a nonaqueous organic solvent and a silylation agent, and a treatment liquid B containing a nonaqueous organic solvent and an acid or a base. The protective film-forming liquid chemical, treatment liquid A, and treatment liquid B transferred by the method for transferring a liquid of the present invention are respectively the same as the protective film-forming liquid chemical, treatment liquid A, and treatment liquid B to be stored in the pressure feed container of the present invention, and thus detailed descriptions thereof are omitted.

The method for transferring a liquid of the present invention includes at least one of (1) and (2) below:

(1) introducing the liquid into the container body through a liquid flowing portion provided with a neutralization mechanism configured to reduce electrostatic potential in the liquid, wherein a liquid contact portion of the liquid flowing portion excluding the neutralization mechanism is formed from a resin material; and
(2) extracting the liquid from the container body containing the liquid through a liquid flowing portion provided with a neutralization mechanism configured to reduce electrostatic potential in the liquid, wherein a liquid contact portion of the liquid flowing portion excluding the neutralization mechanism is formed from a resin material.

The pressure feed container for use in the method for transferring a liquid of the present invention may be the pressure feed container of the present invention provided with a neutralization mechanism, or a pressure feed container not provided with a neutralization mechanism. Examples of such embodiments include a pressure feed container in which a liquid flowing nozzle not provided with a neutralization mechanism is used, and another member (e.g., pipe) provided with a neutralization mechanism is connected to the liquid flowing nozzle of the pressure feed container to transfer a liquid. In the case where the pressure feed container of the present invention provided with a neutralization mechanism is used, the liquid flowing nozzle corresponds to the “liquid flowing portion”. In the case where a pressure feed container not provided with a neutralization mechanism is used, a pipe or the like provided with a neutralization mechanism corresponds to the “liquid flowing portion”. Accordingly, in both of the above cases, the method for transferring a liquid of the present invention allows the transfer of a liquid in the same manner, except for the difference of whether or not the neutralization mechanism forms a part of the pressure feed container. A plurality of the liquid flowing portions may be provided. Also, a plurality of the neutralization mechanisms may be provided. Moreover, in also the case of using the pressure feed container of the present invention, a member other than the pressure feed container may further be provided with a neutralization mechanism.

The neutralization mechanism in the method for transferring a liquid of the present invention has the same structure as that described for the neutralization mechanism provided in the pressure feed container of the present invention. The neutralization mechanism is preferably formed from a grounded conductive material. The neutralization mechanism is more preferably formed such that, in the liquid flowing portion, a part of a surface configured to contact the liquid is formed from a grounded conductive material. Alternatively, the neutralization mechanism is more preferably formed by providing a grounded conductive material in the liquid flowing portion such that the neutralization mechanism is configured to contact the liquid. Examples of the neutralization mechanism include those having any of the following structures: (a) a member formed from a conductive material is connected as a part of the liquid flowing nozzle; (b) the liquid flowing nozzle has a part without a resin lining layer so that a conductive material is exposed; c) a member formed from a conductive material is provided in the liquid flowing nozzle covered with a resin lining layer; and (d) a pipe formed from a conductive material, a pipe having a part without a resin lining layer in the inner surface thereof to expose a conductive material at the part, a pipe having a member formed from a conductive material on the inner surface which is entirely covered with a resin lining layer, or the like is connected to the liquid flowing nozzle of the pressure feed container. The conductive material is as described above.

In the pressure feed container used in the method for transferring a liquid of the present invention, the container body is preferably further provided with a neutralization mechanism configured to reduce electrostatic potential in the liquid. The pressure feed container of the present invention including a container body provided with a neutralization mechanism may be used for sure. Also, the pressure feed container including a liquid flowing nozzle not provided with a neutralization mechanism and a container body provided with a neutralization mechanism may be used. The neutralization mechanism provided in the container body has any structure but preferably includes a rod-like body in which a grounded conductive material is used to form a part of a surface configured to contact the liquid, and a resin material is used to form a liquid contact portion other than the conductive material.

In the case where a pressure feed container not provided with a neutralization mechanism is used in the method for transferring a liquid or the present invention, the structure of the pressure feed container is the same as that of the pressure feed container of the present invention excluding the neutralization mechanism.

The method for transferring a liquid of the present invention preferably includes both of the above (1) and (2) but may include only one of the (1) and (2). In the case where the method includes only one of the (1) and (2), preferably the (1) is performed. In the case where the method includes both of the (1) and (2), the liquid flowing portions provided with the neutralization mechanism may be the same or different ones.

In the method for transferring a liquid of the present invention, each of the protective film-forming liquid chemical, the treatment liquid A, and the treatment liquid B contacts the neutralization mechanism preferably for a long time for reducing electrostatic potential but preferably for a short time for preventing an increase in the number of particles due to metal dissolution in the liquid. Thus, the contact time is preferably 0.001 to 100 seconds, more preferably 0.001 to 10 seconds, and still more preferably 0.01 to 1 second. In the case where a plurality of neutralization mechanisms are provided, the contact time refers to a total time needed to allow the liquid to contact all the neutralization mechanisms.

In the method for transferring a liquid of the present invention, each of the protective film-forming liquid chemical, the treatment liquid A, and the treatment liquid B flows through the liquid flowing portion preferably slowly for reducing electrostatic potential but preferably fast for increasing cost efficiency. Thus, the liquid flows through the liquid flowing portion preferably at a rate of 0.01 to 10 m/sec, and more preferably at a rate of 0.1 to 1 m/sec.

### EXAMPLES

The following gives examples which more specifically disclose the embodiments of the present invention. The present invention is not limited to these examples.

In each of the following examples and comparative examples, a protective film-forming liquid chemical or a protective film-forming liquid chemical kit (hereinafter, also referred to as a “sample liquid”) was introduced into, stored in, and extracted from a pressure feed container, and evaluated by the following processes.

### [Change in Internal Pressure (45° C.)]

A sample liquid was introduced into a pressure feed container and stored at a high temperature of 45° C. for 12 months. The internal pressures (absolute pressures) at 45° C. at the start and end of the high-temperature storage were measured using a bellows manometer attached to the container, and the rate of change in internal pressure was calculated using the following equation. In order to maintain the performance of the liquid, for example, the rate of change is preferably as low as possible. Sample liquids having a rate of change of ±10% passed the evaluation.

Rate of change in internal pressure (%)={(internal pressure at the end of high-temperature storage)−(internal pressure at the start of high-temperature storage)}×100/(internal pressure at the start of high-temperature storage)

### [Change in Concentration of Sample Liquid]

The concentration of a sample liquid (“concentration of protective film-forming agent”, “concentration of silylation agent”, or “concentration of acid or base”) was preliminarily determined by gas chromatography. This sample liquid was introduced into a pressure feed container and stored at a high temperature of 45° C. for 12 months. The concentration of the sample liquid (“concentration of protective film-forming agent”, “concentration of silylation agent”, or “concentration of acid or base”) was determined again, and the rate of decrease in concentration was calculated on the basis of the absolute value derived from the following equation. In order to maintain the performance of the liquid, for example, the rate of decrease is preferably as low as possible, and particularly preferably 10% or lower.

Rate of decrease in concentration (%)={(concentration before high-temperature storage)−(concentration after high-temperature storage)}×100/(concentration before high-temperature storage)

### [Change in Number of Particles in Sample Liquid]

A sample liquid was introduced into a pressure feed container, and part of this sample liquid was extracted from the container through a liquid-extracting nozzle 7 to be mentioned later. The number of particles larger than 0.2 μm per mL in the liquid phase (hereinafter, also referred to simply as the “number of particles”) was measured by particle measurement using a light scattering liquid-borne particle counter. This number of particles is the “number of particles before high-temperature storage”. The remaining sample liquid was stored at a high temperature of 45° C. for 12 months in the pressure feed container, and the number of particles in the sample liquid was measured in the same manner as mentioned above. This number of particles is the “number of particles after high-temperature storage”. For good cleanliness, the number of particles is preferably as small as possible even after the high-temperature storage.

### [Electrostatic Potential of Sample Liquid]

A sample liquid was introduced into a pressure feed container, and part of this sample liquid was extracted from the container through liquid-extracting nozzle 7 to be mentioned later. The electrostatic potential of the sample liquid was measured using an explosion-proof type digital static meter (Model: KSD-0108, KASUGA DENKI, Inc.). This electrostatic potential is the “electrostatic potential after introduction”. Then, the pressure feed container after introduction was reciprocally shaken with an amplitude of 70 mm for one hour. Part of this sample liquid was extracted from the container through the liquid-extracting nozzle 7 to be mentioned later, and the electrostatic potential of the sample liquid was measured in the same manner as mentioned above. This electrostatic potential is the “electrostatic potential after shaking”. Further, the sample liquid was introduced in the same manner as mentioned above, and this sample liquid was extracted from the container through a liquid-introducing and -extracting nozzle 8 to be mentioned later without shaking. The electrostatic potential of this sample liquid was measured in the same manner as mentioned above. This electrostatic potential is the “electrostatic potential after extraction”. For good safety, the electrostatic potential of the sample liquid in any of the above states is preferably as low as possible.

The examples and comparative examples of the present invention used the following sample liquids (1) to (6).

### [Sample Liquid (1)]

Hexamethyldisilazane ((H₃C)₃Si—NH—Si(CH₃)₃) (5 parts by mass), trifluoroacetic anhydride ([CF₃C(O)]₂O) (0.7 parts by mass), and propylene glycol monomethyl ether acetate (PGMEA) as a nonaqueous organic solvent (94.3 parts by mass) were mixed and reacted, thereby providing a liquid containing trimethylsilyl trifluoroacetate ((CH₃)₃Si—OC(O)CF₃) as an acid and hexamethyldisilazane as a protective film-forming agent (silylation agent). Then, metal impurities and particles in the liquid were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (1) as a protective film-forming liquid chemical. The hexamethyldisilazane contained in the liquid chemical of the present example is hexamethyldisilazane not consumed in the aforementioned acid-producing reaction, and this component serves as a protective film-forming agent (silylation agent). The concentration of the protective film-forming agent in the sample liquid (1) was 4.5% by mass.

### [Sample Liquid (2)]

Octyldimethyl(dimethylamino)silane (C₈H₁₇Si(CH₃)₂—N(CH₃)₂) as a silylation agent (10 parts by mass) and PGMEA as a nonaqueous organic solvent (90 parts by mass) were mixed. Then, metal impurities and particles were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (2) as a protective film-forming liquid chemical kit (treatment liquid A). The concentration of the silylation agent in the sample liquid (2) was 10% by mass.

### [Sample Liquid (3)]

Trimethylchlorosilane ((CH₃)₃SiCl) (10 parts by mass) and 2-propanol (iPA) as a nonaqueous organic solvent (90 parts by mass) were mixed and reacted, thereby providing a liquid containing hydrogen chloride as an acid and trimethylisopropoxysilane ((CH₃)₃SiOC₃H₇) as a protective film-forming agent (silylation agent). Then, metal impurities and particles were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (3) as a protective film-forming liquid chemical. The concentration of the protective film-forming agent in the sample liquid (3) was 12.2% by mass.

### [Sample Liquid (4)]

Trimethylsilyldimethylamine ((CH₃)₃Si—N(CH₃)₂) as a silylation agent (5.5 parts by mass) and PGMEA as a nonaqueous organic solvent (94.5 parts by mass) were mixed. Then, metal impurities and particles were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (4) as a protective film-forming liquid chemical kit (treatment liquid A). The concentration of the silylation agent in the sample liquid (4) was 5.5% by mass.

### [Sample Liquid (5)]

Trifluoroacetic anhydride ([CF₃C(O)]₂O) as an acid (1.5 parts by mass) and PGMEA as a nonaqueous organic solvent (98.5 parts by mass) were mixed. Then, metal impurities and particles were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (5) as a protective film-forming liquid chemical kit (treatment liquid B). The concentration of the acid in the sample liquid (5) was 1.5% by mass.

### [Sample Liquid (6)]

Diethylamine (DEA, (C₂H₅)₂NH) as a base (2 parts by mass), Novec 7100 (Sumitomo 3M Limited) as a nonaqueous organic solvent (93 parts by mass), and iPA (5 parts by mass) were mixed. Then, metal impurities and particles were removed using an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger, thereby preparing a sample liquid (6) as a protective film-forming liquid chemical kit (treatment liquid B). The base concentration of the sample liquid (6) was 2% by mass.

### Example 1

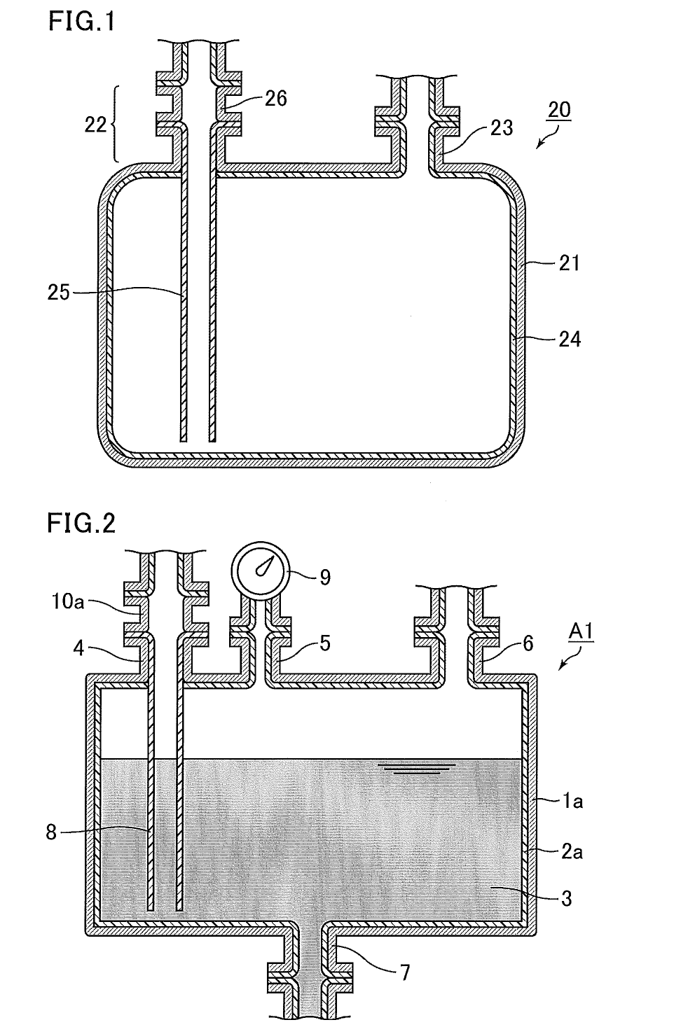

In this example, a pressure feed container A1 shown in FIG. 2 was used. The container Al includes a container body 1a, nozzles 4, 5, 6, and 7, and a neutralization mechanism 10a configured to reduce electrostatic potential. The nozzles 4, 5, 6, and 7 and the neutralization mechanism 10a are formed from SUS304. The container body 1a includes a SUS304 metal can body and a PFA lining layer 2a covering the inner surface of the metal can body. The inner surfaces of the container body 1a and the nozzles 4, 5, 6, and 7, which are configured to contact a sample liquid, are covered with the PFA lining layer 2a. The nozzle 4 is connected with a PFA liquid-introducing and -extracting nozzle 8. The nozzle 5 is connected with a bellows manometer 9 whose liquid contact portion is formed from PFA. The nozzles 4, 6, and 7 are each connected with a valve, a coupler, or the like (not shown). Such connection of the aforementioned components keeps the container airtight. The surfaces configured to contact a sample liquid are covered with the PFA lining layer 2a, or are formed from PFA, excluding the surface of the neutralization mechanism 10a (formed from SUS304). In other words, the SUS304 material of the neutralization mechanism 10a (inner diameter: 28.4 mmφ, length: 50 mm, liquid contact area: 44.6 cm²) is exposed to the surface, and thus can contact a sample liquid. Further, the neutralization mechanism 10a is grounded via a wire or the like (not shown). The portions excluding the liquid contact portion of the neutralization mechanism 10a (e.g. the wire for grounding) do not contact a sample liquid.

A clean pressure feed container was filled with nitrogen gas introduced through the gas-port nozzle 6, and then the sample liquid (1) was introduced into the container as a sample liquid 3 from the liquid flowing nozzle 4 through the liquid-introducing and -extracting nozzle 8 at room temperature (25° C.). In the liquid introduction, an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger was connected with the liquid flowing nozzle 4 and the sample liquid (1) was passed through this ion-exchange resin membrane equipped with the particle-removing membrane so that the particles were removed. At the same time of the liquid introduction, the nitrogen gas was discharged through the gas-port nozzle 6. The liquid introduction and the gas discharge were performed such that the internal gauge pressure in the container was 0.043 MPa after the completion of the liquid introduction.

The container was stored at 45° C. for 12 months. The internal gauge pressure of the container at the start of storage at 45° C. was 0.05 MPa. The internal gauge pressure of the container after 12-month storage at 45° C. was 0.05 MPa, and the rate of change in internal pressure was thus 0%. The concentration of the protective film-forming agent in the sample liquid (1) after 12-month storage was 4.5% by mass, and the rate of decrease in concentration was thus 0%. The sample liquid (1) after 12-month storage contained 13 particles per mL.

Separately, a clean pressure feed container was filled with nitrogen gas introduced through the gas-port nozzle 6, and then the sample liquid (1) was introduced into the container as the sample liquid 3 from the liquid flowing nozzle 4 through the liquid-introducing and -extracting nozzle 8. The sample liquid (1) was extracted from the container through the liquid-extracting nozzle 7 after the liquid introduction was completed, and the electrostatic potential of the liquid was measured to be 0.6 kV. The above operation was followed by shaking the pressure feed container. Then, the sample liquid (1) was extracted from the container through the liquid-extracting nozzle 7 in the same manner as mentioned above, and the electrostatic potential of the liquid was measured to be 0.6 kV. After liquid introduction in the same manner as mentioned above, the sample liquid (1) was extracted from the container through the liquid-introducing and -extracting nozzle 8 from the liquid flowing nozzle 4 without shaking, and the electrostatic potential of the liquid was measured to be 0.1 kV. In this example, the sample liquid was introduced and extracted at a rate of 0.5 m/sec, and the sample liquid contacted the neutralization mechanism for 0.1 seconds (liquid contact time). Table 1 shows the evaluation conditions and Table 2 shows the evaluation results.

### Example 2

The same operations were performed as in Example 1 except that the metal can body of the container body 1a and the neutralization mechanism 10a formed from electropolished SUS316L were used. Table 1 shows the evaluation conditions and Table 2 shows the evaluation results.

### Example 3

In this example, a pressure feed container A2 shown in FIG. 3 was used. The container A2 includes, as a neutralization mechanism 10b, a SUS304 sleeve member (inner diameter: 28.4 mφ, length: 10 mm, liquid contact area: 8.9 cm²) incorporated with the nozzle 4, and the sleeve member is configured to contact a sample liquid. The neutralization mechanism 10b (sleeve member) is grounded via a wire or the like (not shown). The portions (e.g. the wire for grounding) excluding the liquid contact portion of the neutralization mechanism 10b do not contact a sample liquid. Except for the above, the container A2 has a structure similar to that of the pressure feed container A1 shown in FIG. 2. The same operations were performed as in Example 1 except that the above pressure feed container A2 was used. Table 1 shows the evaluation conditions and Table 2 shows the evaluation results.

### Example 4

The same operations were performed as in Example 3 except that the metal can body of the container body 1a and the neutralization mechanism 10b (sleeve member) formed from electropolished SUS316L were used. Table 1 shows the evaluation conditions and Table 2 shows the evaluation results.

### Example 5

In this example, a pressure feed container A3 shown in FIG. 4 was used. The structure of the container A3 is a combination of the pressure feed container Al shown in FIG. 2 and a neutralization mechanism 12 configured to reduce electrostatic potential. For the pressure feed container A3, the surface of a SUS304 rod-like body 11, excluding the portion of the neutralization mechanism 12, was covered with a PFA lining layer 2a. In other words, the SUS304 rod-like body 11 was exposed to the surface at the portion of the neutralization mechanism 12 (liquid contact area: 200 mm²), and thus can contact a sample liquid. The neutralization mechanism 12 (rod-like body 11) is grounded via a wire or the like (not shown). The portions (e.g. the wire for grounding) excluding the neutralization mechanism 12 (the liquid contact portion of the rod-like body 11) do not contact a sample liquid. The same operations were performed as in Example 1 except that the aforementioned pressure feed container A3 was used. Table 1 shows the evaluation conditions and Table 2 shows the evaluation results.

### Comparative Example 1

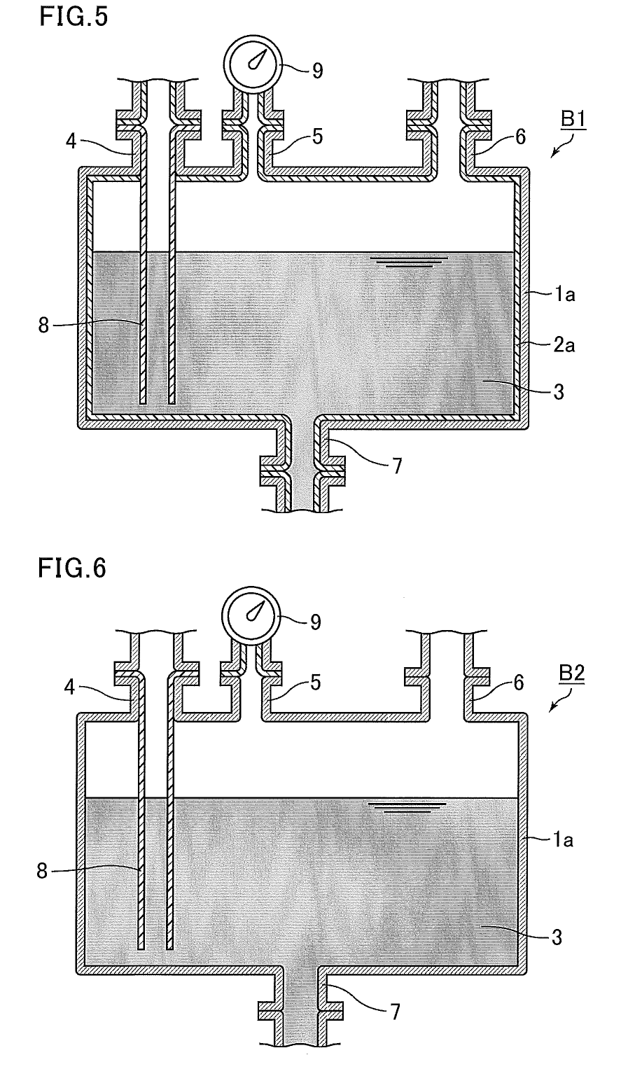

The same operations were performed as in Example 1 except that a pressure feed container B1 without a neutralization mechanism shown in FIG. 5 was used. Table 1 shows the evaluation conditions and Table 2 shows the evaluation results.

### Comparative Example 2

The same operations were performed as in Example 1 except that a pressure feed container B2 without a lining layer shown in FIG. 6 was used. Table 1 shows the evaluation conditions and Table 2 shows the evaluation results.

TABLE 1

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 1 | SUS304 | PFA | Present | Present | Absent | SUS304 | 28.4 |
| Example 2 | Electropolished | PFA | Present | Present | Absent | Electropolished | 28.4 |
| | SUS316L | | | | | SUS316L | |
| Example 3 | SUS304 | PFA | Present | Present | Absent | SUS304 | 28.4 |
| Example 4 | Electropolished | PFA | Present | Present | Absent | Electropolished | 28.4 |
| | SUS316L | | | | | SUS316L | |
| Example 5 | SUS304 | PFA | Present | Present | Present | SUS304 | 28.4 |
| Comparative | SUS304 | PFA | Absent | Absent | Absent | Absent | — |
| Example 1 | | | | | | | |
| Comparative | SUS304 | Absent | — | — | — | — | — |
| Example 2 | | | | | | | |

| | Neutralization mechanism | | | | | | |
|---|---|---|---|---|---|---|---|
| | Conductive material of neutralization | | | | | | |
| | mechanism disposed on liquid | | | | | | |
| | flowing nozzle | | | | | | |
| | | Liquid | Liquid | Protective film-forming | | | |
| | | contact | contact | liquid chemical | | | Liquid |
| | Length | area | time | Protective film- | Acid or | Nonaqueous | flowing rate |
| | [mm] | [cm²] | [Sec] | forming agent | base | solvent | [m/sec] |
| Example 1 | 50 | 44.6 | 0.1 | Hexamethyl | Trimethylsilyl | PGMEA | 0.5 |
| | | | | disilazane | trifluoroacetate | | |
| Example 2 | 50 | 44.6 | 0.1 | Hexamethyl | Trimethylsilyl | PGMEA | 0.5 |
| | | | | disilazane | trifluoroacetate | | |
| Example 3 | 10 | 8.9 | 0.02 | Hexamethyl | Trimethylsilyl | PGMEA | 0.5 |
| | | | | disilazane | trifluoroacetate | | |
| Example 4 | 10 | 8.9 | 0.02 | Hexamethyl | Trimethylsilyl | PGMEA | 0.5 |
| | | | | disilazane | trifluoroacetate | | |
| Example 5 | 50 | 44.6 | 0.1 | Hexamethyl | Trimethylsilyl | PGMEA | 0.5 |
| | | | | disilazane | trifluoroacetate | | |
| Comparative | — | — | — | Hexamethyl | Trimethylsilyl | PGMEA | 0.5 |
| Example 1 | | | | disilazane | trifluoroacetate | | |
| Comparative | — | — | — | Hexamethyl | Trimethylsilyl | PGMEA | 0.5 |
| Example 2 | | | | disilazane | trifluoroacetate | | |

TABLE 2

| | Internal pressure (45° C.) | | | Concentration of | | |
|---|---|---|---|---|---|---|
| | At the start | At the end | | protective film-forming agent | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 1 | 0.05 | 0.05 | 0 | 4.5 | 4.5 | 0 |
| Example 2 | 0.05 | 0.05 | 0 | 4.5 | 4.5 | 0 |
| Example 3 | 0.05 | 0.05 | 0 | 4.5 | 4.5 | 0 |
| Example 4 | 0.05 | 0.05 | 0 | 4.5 | 4.5 | 0 |
| Example 5 | 0.05 | 0.05 | 0 | 4.5 | 4.5 | 0 |
| Comparative | 0.05 | 0.05 | 0 | 4.5 | 4.5 | 0 |
| Example 1 | | | | | | |
| Comparative | 0.05 | 0.05 | 0 | 4.5 | 4.3 | 4 |
| Example 2 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 1 | 8 | 13 | 0.6 | 0.6 | 0.1 |
| Example 2 | 7 | 9 | 0.7 | 0.6 | 0.1 |
| Example 3 | 5 | 9 | 0.8 | 0.7 | 0.2 |
| Example 4 | 7 | 8 | 0.7 | 0.7 | 0.2 |
| Example 5 | 9 | 16 | 0.5 | 0.1 | 0.1 |
| Comparative | 6 | 8 | 30 | 34 | 31 |
| Example 1 | | | | | |
| Comparative | 57 | 312 | 0.2 | 0.1 | 0.1 |
| Example 2 | | | | | |

### Examples 6 to 10, Comparative Examples 3 and 4

The same operations were performed as in Examples 1 to 5 and Comparative Examples 1 and 2, respectively, except that the sample liquid (2) was used as a sample liquid. Table 3 shows the evaluation conditions and Table 4 shows the evaluation results.

TABLE 3

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 6 | SUS304 | PFA | Present | Present | Absent | SUS304 | 28.4 |
| Example 7 | Electropolished | PFA | Present | Present | Absent | Electropolished | 28.4 |
| | SUS316L | | | | | SUS316L | |
| Example 8 | SUS304 | PFA | Present | Present | Absent | SUS304 | 28.4 |
| Example 9 | Electropolished | PFA | Present | Present | Absent | Electropolished | 28.4 |
| | SUS316L | | | | | SUS316L | |
| Example 10 | SUS304 | PFA | Present | Present | Present | SUS304 | 28.4 |
| Comparative | SUS304 | PFA | Absent | Absent | Absent | Absent | — |
| Example 3 | | | | | | | |
| Comparative | SUS304 | Absent | — | — | — | — | — |
| Example 4 | | | | | | | |

| | Neutralization mechanism | | | | | |
|---|---|---|---|---|---|---|
| | Conductive material of neutralization | | | | | |
| | mechanism disposed on liquid | | | | | |
| | flowing nozzle | | | | | |
| | | Liquid | Liquid | | | |
| | | contact | contact | Treatment liquid A | | Liquid |
| | Length | area | time | Silylation | Nonaqueous | flowing rate |
| | [mm] | [cm²] | [Sec] | agent | solvent | [m/sec] |
| Example 6 | 50 | 44.6 | 0.1 | Octyldimethyl | PGMEA | 0.5 |
| | | | | (dimethylamino) | | |
| | | | | silane | | |
| Example 7 | 50 | 44.6 | 0.1 | Octyldimethyl | PGMEA | 0.5 |
| | | | | (dimethylamino) | | |
| | | | | silane | | |
| Example 8 | 10 | 8.9 | 0.02 | Octyldimethyl | PGMEA | 0.5 |
| | | | | (dimethylamino) | | |
| | | | | silane | | |
| Example 9 | 10 | 8.9 | 0.02 | Octyldimethyl | PGMEA | 0.5 |
| | | | | (dimethylamino) | | |
| | | | | silane | | |
| Example 10 | 50 | 44.6 | 0.1 | Octyldimethyl | PGMEA | 0.5 |
| | | | | (dimethylamino) | | |
| | | | | silane | | |
| Comparative | — | — | — | Octyldimethyl | PGMEA | 0.5 |
| Example 3 | | | | (dimethylamino) | | |
| | | | | silane | | |
| Comparative | — | — | — | Octyldimethyl | PGMEA | 0.5 |
| Example 4 | | | | (dimethylamino) | | |
| | | | | silane | | |

TABLE 4

| | Internal pressure (45° C.) | | | Concentration of | | |
|---|---|---|---|---|---|---|
| | At the start | At the end | | silylation agent | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 6 | 0.05 | 0.05 | 0 | 10 | 10 | 0 |
| Example 7 | 0.05 | 0.05 | 0 | 10 | 10 | 0 |
| Example 8 | 0.05 | 0.05 | 0 | 10 | 10 | 0 |
| Example 9 | 0.05 | 0.05 | 0 | 10 | 10 | 0 |
| Example 10 | 0.05 | 0.05 | 0 | 10 | 10 | 0 |
| Comparative | 0.05 | 0.05 | 0 | 10 | 10 | 0 |
| Example 3 | | | | | | |
| Comparative | 0.05 | 0.05 | 0 | 10 | 9.8 | 2 |
| Example 4 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 6 | 10 | 16 | 0.7 | 0.8 | 0.2 |
| Example 7 | 8 | 11 | 0.6 | 0.6 | 0.1 |
| Example 8 | 9 | 14 | 0.8 | 0.7 | 0.2 |
| Example 9 | 6 | 9 | 0.7 | 0.7 | 0.2 |
| Example 10 | 12 | 19 | 0.8 | 0.1 | 0.1 |
| Comparative | 7 | 10 | 27 | 30 | 28 |
| Example 3 | | | | | |
| Comparative | 70 | 467 | 0.3 | 0.2 | 0.1 |
| Example 4 | | | | | |

### Examples 11 to 15, Comparative Examples 5 and 6

The same operations were performed as in Examples 1 to 5 and Comparative Examples 1 and 2, respectively, except that the sample liquid (3) was used as a sample liquid. Table 5 shows the evaluation conditions and Table 6 shows the evaluation results.

TABLE 5

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 11 | SUS304 | PFA | Present | Present | Absent | SUS304 | 28.4 |
| Example 12 | Electropolished | PFA | Present | Present | Absent | Electropolished | 28.4 |
| | SUS316L | | | | | SUS316L | |
| Example 13 | SUS304 | PFA | Present | Present | Absent | SUS304 | 28.4 |
| Example 14 | Electropolished | PFA | Present | Present | Absent | Electropolished | 28.4 |
| | SUS316L | | | | | SUS316L | |
| Example 15 | SUS304 | PFA | Present | Present | Present | SUS304 | 28.4 |
| Comparative | SUS304 | PFA | Absent | Absent | Absent | Absent | — |
| Example 5 | | | | | | | |
| Comparative | SUS304 | Absent | — | — | — | — | — |
| Example 6 | | | | | | | |

| | Neutralization mechanism | | | | | | |
|---|---|---|---|---|---|---|---|
| | Conductive material of neutralization | | | | | | |
| | mechanism disposed on liquid | | | | | | |
| | flowing nozzle | | | | | | |
| | | Liquid | Liquid | Protective film-forming | | | |
| | | contact | contact | liquid chemical | | | Liquid |
| | Length | area | time | Protective film- | Acid or | Nonaqueous | flowing rate |
| | [mm] | [cm²] | [Sec] | forming agent | base | solvent | [m/sec] |
| Example 11 | 50 | 44.6 | 0.1 | Trimethyl | Hydrogen | iPA | 0.5 |
| | | | | isopropoxy | chloride | | |
| | | | | silane | | | |
| Example 12 | 50 | 44.6 | 0.1 | Trimethyl | Hydrogen | iPA | 0.5 |
| | | | | isopropoxy | chloride | | |
| | | | | silane | | | |
| Example 13 | 10 | 8.9 | 0.02 | Trimethyl | Hydrogen | iPA | 0.5 |
| | | | | isopropoxy | chloride | | |
| | | | | silane | | | |
| Example 14 | 10 | 8.9 | 0.02 | Trimethyl | Hydrogen | iPA | 0.5 |
| | | | | isopropoxy | chloride | | |
| | | | | silane | | | |
| Example 15 | 50 | 44.6 | 0.1 | Trimethyl | Hydrogen | iPA | 0.5 |
| | | | | isopropoxy | chloride | | |
| | | | | silane | | | |
| Comparative | — | — | — | Trimethyl | Hydrogen | iPA | 0.5 |
| Example 5 | | | | isopropoxy | chloride | | |
| | | | | silane | | | |
| Comparative | — | — | — | Trimethyl | Hydrogen | iPA | 0.5 |
| Example 6 | | | | isopropoxy | chloride | | |
| | | | | silane | | | |

TABLE 6

| | Internal pressure (45° C.) | | | Concentration of | | |
|---|---|---|---|---|---|---|
| | At the start | At the end | | protective film-forming agent | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 11 | 0.05 | 0.05 | 0 | 12.2 | 12.2 | 0 |
| Example 12 | 0.05 | 0.05 | 0 | 12.2 | 12.2 | 0 |
| Example 13 | 0.05 | 0.05 | 0 | 12.2 | 12.2 | 0 |
| Example 14 | 0.05 | 0.05 | 0 | 12.2 | 12.2 | 0 |
| Example 15 | 0.05 | 0.05 | 0 | 12.2 | 12.2 | 0 |
| Comparative | 0.05 | 0.05 | 0 | 12.2 | 12.2 | 0 |
| Example 5 | | | | | | |
| Comparative | 0.05 | 0.05 | 0 | 12.2 | 11.9 | 3 |
| Example 6 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 11 | 12 | 17 | 0.6 | 0.7 | 0.1 |
| Example 12 | 9 | 12 | 0.7 | 0.6 | 0.2 |
| Example 13 | 10 | 15 | 0.8 | 0.7 | 0.2 |
| Example 14 | 7 | 10 | 0.7 | 0.6 | 0.2 |
| Example 15 | 13 | 20 | 0.3 | 0.1 | 0.1 |
| Comparative | 8 | 11 | 39 | 37 | 38 |
| Example 5 | | | | | |
| Comparative | 68 | 511 | 0.2 | 0.1 | 0.1 |
| Example 6 | | | | | |

### Examples 16 to 20, Comparative Examples 7 and 8

The same operations were performed as in Examples 1 to 5 and Comparative Examples 1 and 2, respectively, except that the sample liquid (4) was used as a sample liquid. Table 7 shows the evaluation conditions and Table 8 shows the evaluation results.

TABLE 7

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 16 | SUS304 | PFA | Present | Present | Absent | SUS304 | 28.4 |
| Example 17 | Electropolished | PFA | Present | Present | Absent | Electropolished | 28.4 |
| | SUS316L | | | | | SUS316L | |
| Example 18 | SUS304 | PFA | Present | Present | Absent | SUS304 | 28.4 |
| Example 19 | Electropolished | PFA | Present | Present | Absent | Electropolished | 28.4 |
| | SUS316L | | | | | SUS316L | |
| Example 20 | SUS304 | PFA | Present | Present | Present | SUS304 | 28.4 |
| Comparative | SUS304 | PFA | Absent | Absent | Absent | Absent | — |
| Example 7 | | | | | | | |
| Comparative | SUS304 | Absent | — | — | — | — | — |
| Example 8 | | | | | | | |

| | Neutralization mechanism | | | | | |
|---|---|---|---|---|---|---|
| | Conductive material of neutralization | | | | | |
| | mechanism disposed on liquid | | | | | |
| | flowing nozzle | | | | | |
| | | Liquid | Liquid | | | |
| | | contact | contact | Treatment liquid A | | Liquid |
| | Length | area | time | Silylation | Nonaqueous | flowing rate |
| | [mm] | [cm²] | [Sec] | agent | solvent | [m/sec] |
| Example 16 | 50 | 44.6 | 0.1 | Trimethyl | PGMEA | 0.5 |
| | | | | silyldimethyl | | |
| | | | | amine | | |
| Example 17 | 50 | 44.6 | 0.1 | Trimethyl | PGMEA | 0.5 |
| | | | | silyldimethyl | | |
| | | | | amine | | |
| Example 18 | 10 | 8.9 | 0.02 | Trimethyl | PGMEA | 0.5 |
| | | | | silyldimethyl | | |
| | | | | amine | | |
| Example 19 | 10 | 8.9 | 0.02 | Trimethyl | PGMEA | 0.5 |
| | | | | silyldimethyl | | |
| | | | | amine | | |
| Example 20 | 50 | 44.6 | 0.1 | Trimethyl | PGMEA | 0.5 |
| | | | | silyldimethyl | | |
| | | | | amine | | |
| Comparative | — | — | — | Trimethyl | PGMEA | 0.5 |
| Example 7 | | | | silyldimethyl | | |
| | | | | amine | | |
| Comparative | — | — | — | Trimethyl | PGMEA | 0.5 |
| Example 8 | | | | silyldimethyl | | |
| | | | | amine | | |

TABLE 8

| | Internal pressure (45° C.) | | | Concentration of | | |
|---|---|---|---|---|---|---|
| | At the start | At the end | | silylation agent | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 16 | 0.05 | 0.05 | 0 | 5.5 | 5.5 | 0 |
| Example 17 | 0.05 | 0.05 | 0 | 5.5 | 5.5 | 0 |
| Example 18 | 0.05 | 0.05 | 0 | 5.5 | 5.5 | 0 |
| Example 19 | 0.05 | 0.05 | 0 | 5.5 | 5.5 | 0 |
| Example 20 | 0.05 | 0.05 | 0 | 5.5 | 5.5 | 0 |
| Comparative | 0.05 | 0.05 | 0 | 5.5 | 5.5 | 0 |
| Example 7 | | | | | | |
| Comparative | 0.05 | 0.05 | 0 | 5.5 | 5.4 | 2 |
| Example 8 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 16 | 11 | 16 | 0.7 | 0.6 | 0.1 |
| Example 17 | 9 | 12 | 0.6 | 0.6 | 0.1 |
| Example 18 | 9 | 13 | 0.8 | 0.7 | 0.2 |
| Example 19 | 7 | 10 | 0.7 | 0.7 | 0.2 |
| Example 20 | 12 | 18 | 0.2 | 0.1 | 0.1 |
| Comparative | 7 | 11 | 27 | 25 | 24 |
| Example 7 | | | | | |
| Comparative | 48 | 286 | 0.2 | 0.1 | 0.1 |
| Example 8 | | | | | |

### Examples 21 to 25, Comparative Examples 9 and 10

The same operations were performed as in Examples 1 to 5 and Comparative Examples 1 and 2, respectively, except that the sample liquid (5) was used as a sample liquid. Table 9 shows the evaluation conditions and Table 10 shows the evaluation results.

TABLE 9

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 21 | SUS304 | PFA | Present | Present | Absent | SUS304 | 28.4 |
| Example 22 | Electropolished | PFA | Present | Present | Absent | Electropolished | 28.4 |
| | SUS316L | | | | | SUS316L | |
| Example 23 | SUS304 | PFA | Present | Present | Absent | SUS304 | 28.4 |
| Example 24 | Electropolished | PFA | Present | Present | Absent | Electropolished | 28.4 |
| | SUS316L | | | | | SUS316L | |
| Example 25 | SUS304 | PFA | Present | Present | Present | SUS304 | 28.4 |
| Comparative | SUS304 | PFA | Absent | Absent | Absent | Absent | — |
| Example 9 | | | | | | | |
| Comparative | SUS304 | Absent | — | — | — | — | — |
| Example 10 | | | | | | | |

| | Neutralization mechanism | | | | | |
|---|---|---|---|---|---|---|
| | Conductive material of neutralization | | | | | |
| | mechanism disposed on liquid | | | | | |
| | flowing nozzle | | | | | |
| | | Liquid | Liquid | | | |
| | | contact | contact | Treatment liquid B | | Liquid |
| | Length | area | time | Acid or | Nonaqueous | flowing rate |
| | [mm] | [cm²] | [Sec] | base | solvent | [m/sec] |
| Example 21 | 50 | 44.6 | 0.1 | Anhydrous | PGMEA | 0.5 |
| | | | | trifluoroacetic | | |
| | | | | acid | | |
| Example 22 | 50 | 44.6 | 0.1 | Anhydrous | PGMEA | 0.5 |
| | | | | trifluoroacetic | | |
| | | | | acid | | |
| Example 23 | 10 | 8.9 | 0.02 | Anhydrous | PGMEA | 0.5 |
| | | | | trifluoroacetic | | |
| | | | | acid | | |
| Example 24 | 10 | 8.9 | 0.02 | Anhydrous | PGMEA | 0.5 |
| | | | | trifluoroacetic | | |
| | | | | acid | | |
| Example 25 | 50 | 44.6 | 0.1 | Anhydrous | PGMEA | 0.5 |
| | | | | trifluoroacetic | | |
| | | | | acid | | |
| Comparative | — | — | — | Anhydrous | PGMEA | 0.5 |
| Example 9 | | | | trifluoroacetic | | |
| | | | | acid | | |
| Comparative | — | — | — | Anhydrous | PGMEA | 0.5 |
| Example 10 | | | | trifluoroacetic | | |
| | | | | acid | | |

TABLE 10

| | Internal pressure (45° C.) | | | Concentration of | | |
|---|---|---|---|---|---|---|
| | At the start | At the end | | acid | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 21 | 0.05 | 0.05 | 0 | 1.5 | 1.5 | 0 |
| Example 22 | 0.05 | 0.05 | 0 | 1.5 | 1.5 | 0 |
| Example 23 | 0.05 | 0.05 | 0 | 1.5 | 1.5 | 0 |
| Example 24 | 0.05 | 0.05 | 0 | 1.5 | 1.5 | 0 |
| Example 25 | 0.05 | 0.05 | 0 | 1.5 | 1.5 | 0 |
| Comparative | 0.05 | 0.05 | 0 | 1.5 | 1.5 | 0 |
| Example 9 | | | | | | |
| Comparative | 0.05 | 0.05 | 0 | 1.5 | 1.3 | 13 |
| Example 10 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 21 | 8 | 13 | 0.7 | 0.6 | 0.1 |
| Example 22 | 7 | 11 | 0.8 | 0.7 | 0.2 |
| Example 23 | 9 | 13 | 0.9 | 0.8 | 0.2 |
| Example 24 | 6 | 9 | 0.8 | 0.7 | 0.1 |
| Example 25 | 10 | 16 | 0.3 | 0.2 | 0.1 |
| Comparative | 6 | 9 | 26 | 23 | 22 |
| Example 9 | | | | | |
| Comparative | 55 | 256 | 0.3 | 0.2 | 0.1 |
| Example 10 | | | | | |

### Examples 26 to 30, Comparative Examples 11 and 12

The same operations were performed as in Examples 1 to 5 and Comparative Examples 1 and 2, respectively, except that the sample liquid (6) was used as a sample liquid. Table 11 shows the evaluation conditions and Table 12 shows the evaluation results.

TABLE 11

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material of | Material | | | introduction | | Inner |
| | container | of resin | | | and | | diameter |
| | body | lining | Introduction | Extraction | extraction | Material | [mmφ] |
| Example 26 | SUS304 | PFA | Present | Present | Absent | SUS304 | 28.4 |
| Example 27 | Electropolished | PFA | Present | Present | Absent | Electropolished | 28.4 |
| | SUS316L | | | | | SUS316L | |
| Example 28 | SUS304 | PFA | Present | Present | Absent | SUS304 | 28.4 |
| Example 29 | Electropolished | PFA | Present | Present | Absent | Electropolished | 28.4 |
| | SUS316L | | | | | SUS316L | |
| Example 30 | SUS304 | PFA | Present | Present | Present | SUS304 | 28.4 |
| Comparative | SUS304 | PFA | Absent | Absent | Absent | Absent | — |
| Example 11 | | | | | | | |
| Comparative | SUS304 | Absent | — | — | — | — | — |
| Example 12 | | | | | | | |

| | Neutralization mechanism | | | | | |
|---|---|---|---|---|---|---|
| | Conductive material of neutralization | | | | | |
| | mechanism disposed on liquid | | | | | |
| | flowing nozzle | | | | | |
| | | Liquid | Liquid | | | |
| | | contact | contact | Treatment liquid B | | Liquid |
| | Length | area | time | Acid or | Nonaqueous | flowing rate |
| | [mm] | [cm²] | [Sec] | base | solvent | [m/sec] |
| Example 26 | 50 | 44.6 | 0.1 | DEA | Novec7100 + | 0.5 |
| | | | | | iPA | |
| Example 27 | 50 | 44.6 | 0.1 | DEA | Novec7100 + | 0.5 |
| | | | | | iPA | |
| Example 28 | 10 | 8.9 | 0.02 | DEA | Novec7100 + | 0.5 |
| | | | | | iPA | |
| Example 29 | 10 | 8.9 | 0.02 | DEA | Novec7100 + | 0.5 |
| | | | | | iPA | |
| Example 30 | 50 | 44.6 | 0.1 | DEA | Novec7100 + | 0.5 |
| | | | | | iPA | |
| Comparative | — | — | — | DEA | Novec7100 + | 0.5 |
| Example 11 | | | | | iPA | |
| Comparative | — | — | — | DEA | Novec7100 + | 0.5 |
| Example 12 | | | | | iPA | |

TABLE 12

| | Internal pressure (45° C.) | | | concentration of | | |
|---|---|---|---|---|---|---|
| | At the start | At the end | | base | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 26 | 0.05 | 0.05 | 0 | 2 | 2 | 0 |
| Example 27 | 0.05 | 0.05 | 0 | 2 | 2 | 0 |
| Example 28 | 0.05 | 0.05 | 0 | 2 | 2 | 0 |
| Example 29 | 0.05 | 0.05 | 0 | 2 | 2 | 0 |
| Example 30 | 0.05 | 0.05 | 0 | 2 | 2 | 0 |
| Comparative | 0.05 | 0.05 | 0 | 2 | 2 | 0 |
| Example 11 | | | | | | |
| Comparative | 0.05 | 0.05 | 0 | 2 | 1.9 | 5 |
| Example 12 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 26 | 6 | 12 | 0.7 | 0.8 | 0.2 |
| Example 27 | 5 | 9 | 0.7 | 0.7 | 0.2 |
| Example 28 | 6 | 10 | 0.9 | 0.8 | 0.3 |
| Example 29 | 4 | 8 | 0.9 | 0.7 | 0.2 |
| Example 30 | 8 | 13 | 0.4 | 0.1 | 0.1 |
| Comparative | 4 | 7 | 44 | 41 | 40 |
| Example 11 | | | | | |
| Comparative | 32 | 125 | 0.3 | 0.1 | 0.1 |
| Example 12 | | | | | |

### Example 31

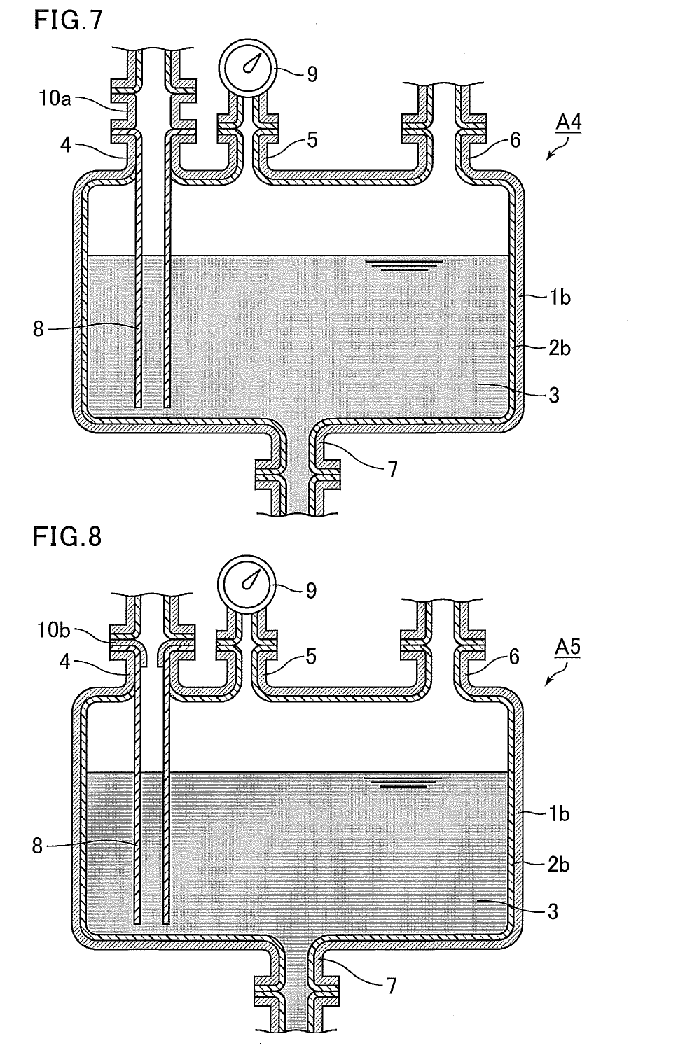

In this example, a pressure feed container A4 shown in FIG. 7 was used. The container A4 includes a container body 1b, nozzles 4, 5, 6, and 7, and a neutralization mechanism 10a configured to reduce electrostatic potential. The nozzles 4, 5, 6, and 7 and the neutralization mechanism 10a are formed from SUS304. The container body 1b includes a bag-shaped resin can body 2b (hereinafter, also referred to as a “PFA layer 2b”) formed by rotation-molding of PFA and a SUS304 metal can body covering the exterior of the resin can body 2b. In the same manner as in Examples 1 to 30, the surfaces of the container body 1b and the nozzles 4, 5, 6, and 7, which are configured to contact a sample liquid, are covered with the PFA layer 2b. The nozzle 4 is connected with a PFA liquid-introducing and -extracting nozzle 8. The nozzle 5 is connected with a bellows manometer 9 whose liquid contact portion is formed from PFA. The nozzles 4, 6, and 7 are each connected with a valve, a coupler, or the like (not shown). Such connection of the aforementioned components keeps the container airtight. The surfaces configured to contact a sample liquid are the PFA layer 2b or are PFA nozzles excluding the surface of the neutralization mechanism 10a (formed from SUS304). In other words, the SUS304 material of the neutralization mechanism 10a (inner diameter: 28.4 mmφ, length: 50 mm, liquid contact area: 44.6 cm²) is exposed to the surface, and thus can contact a sample liquid. Further, the neutralization mechanism 10a is grounded via a wire or the like (not shown). The portions excluding the liquid contact portion of the neutralization mechanism 10a (e.g. the wire for grounding) do not contact a sample liquid.

A clean pressure feed container was filled with nitrogen gas introduced through the gas-port nozzle 6, and then the sample liquid (1) was introduced into the container as a sample liquid 3 from the liquid flowing nozzle 4 through the liquid-introducing and -extracting nozzle 8 at room temperature (25° C.). In the liquid introduction, an ion-exchange resin membrane (Protego Plus LTX, product No.: PRLZ02PQ1K, Nihon Entegris K. K., surface area of membrane: 1.38 m²) equipped with a particle-removing membrane which can remove particles of 0.05 μm or larger was connected with the liquid flowing nozzle 4 and the sample liquid (1) was passed through this ion-exchange resin membrane equipped with the particle-removing membrane to remove the particles. At the same time of the liquid introduction, the nitrogen gas was discharged through the gas-port nozzle 6. The liquid introduction and the gas discharge were performed such that the internal gauge pressure in the container was 0.043 MPa after the completion of the liquid introduction.

The container was stored at 45° C. for 12 months. The internal gauge pressure of the container at the start of storage at 45° C. was 0.05 MPa. The internal gauge pressure of the container after 12-month storage at 45° C. was 0.05 MPa, and the rate of change in internal pressure was thus 0%. The concentration of the protective film-forming agent in the sample liquid (1) after 12-month storage was 4.5% by mass, and the rate of decrease in concentration was thus 0%. The sample liquid (1) after 12-month storage contained 17 particles per mL.

Separately, a clean pressure feed container was filled with nitrogen gas introduced through a gas-port nozzle 6, and then the sample liquid (1) was introduced into the container as a sample liquid 3 from the liquid flowing nozzle 4 through the liquid-introducing and -extracting nozzle 8. The sample liquid (1) was extracted from the container through the liquid-extracting nozzle 7 after the liquid introduction was completed, and the electrostatic potential of the liquid was measured to be 0.5 kV. The above operation was followed by shaking the pressure feed container. Then, the sample liquid (1) was extracted from the container through the liquid-extracting nozzle 7 in the same manner as mentioned above, and the electrostatic potential of the liquid was measured to be 0.5 kV. After liquid introduction in the same manner as mentioned above, the sample liquid (1) was extracted from the container through the liquid-introducing and -extracting nozzle 8 from the liquid flowing nozzle 4 without shaking, and the electrostatic potential of the liquid was measured to be 0.1 kV. In this example, the sample liquid was introduced and extracted at a rate of 0.5 m/sec, and the sample liquid contacted the neutralization mechanism for 0.1 seconds (liquid contact time). Table 13 shows the evaluation conditions and Table 14 shows the evaluation results.

### Example 32

The same operations were performed as in Example 31 except that the metal can body covering the exterior of the resin can body 2b and the neutralization mechanism 10a formed from electropolished SUS316L were used. Table 13 shows the evaluation conditions and Table 14 shows the evaluation results.

### Example 33

In this example, a pressure feed container AS shown in FIG. 8 was used. The container AS includes, as the neutralization mechanism 10b, a SUS304 sleeve member (inner diameter: 28.4 mmφ, length: 10 mm, liquid contact area: 8.9 cm²) incorporated with the nozzle 4, and the sleeve member is configured to contact a sample liquid. The neutralization mechanism 10b (sleeve member) is grounded via a wire or the like (not shown). The portions (e.g. the wire for grounding) excluding the liquid contact portion of the neutralization mechanism 10b do not contact a sample liquid. Except for the above, the container AS has a structure similar to that of the pressure feed container A4 shown in FIG. 7. The same operations were performed as in Example 1 except that the above pressure feed container AS was used. Table 13 shows the evaluation conditions and Table 14 shows the evaluation results.

### Example 34

The same operations were performed as in Example 33 except that the metal can body covering the exterior of the resin can body 2b and the neutralization mechanism 10b (sleeve member) formed from electropolished SUS316L were used. Table 13 shows the evaluation conditions and Table 14 shows the evaluation results.

### Example 35

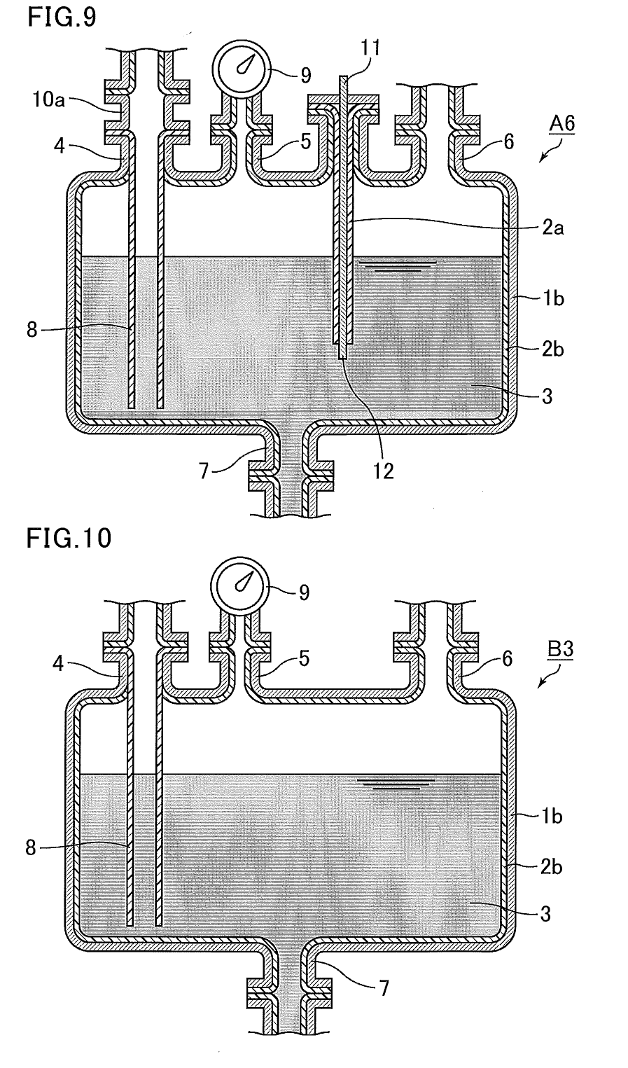

In this example, a pressure feed container A6 shown in FIG. 9 was used. The container A6 includes a pressure feed container A4 shown in FIG. 7 and a neutralization mechanism 12 configured to reduce electrostatic potential. For the pressure feed container A6, the surface of a SUS304 rod-like body 11, excluding the portion of the neutralization mechanism 12, was covered with a PFA lining layer 2a. In other words, the SUS304 rod-like body 11 was exposed to the surface at the portion of the neutralization mechanism 12 (liquid contact area: 200 mm²), and thus can contact a sample liquid. The neutralization mechanism 12 (rod-like body 11) is grounded via a wire or the like (not shown). The portions (e.g. the wire for grounding) excluding the neutralization mechanism 12 (the liquid contact portion of the rod-like body 11) do not contact a sample liquid. The same operations were performed as in Example 31 except that the aforementioned pressure feed container A6 was used. Table 13 shows the evaluation conditions and Table 14 shows the evaluation results.

### Comparative Example 13

The same operations were performed as in Example 31 except that a pressure feed container B3 without a neutralization mechanism shown in FIG. 10 was used. Table 13 shows the evaluation conditions and Table 14 shows the evaluation results.

TABLE 13

| | | | Neutralization mechanism | | | | |
|---|---|---|---|---|---|---|---|
| | | | | | | Conductive material of neutralization | |
| | | | | | | mechanism disposed on liquid | |
| | | | | | Except for | flowing nozzle | |
| | Material | Material | | | introduction | | Inner |
| | of resin | of metal | | | and | | diameter |
| | can body | can body | Introduction | Extraction | extraction | Material | [mmφ] |
| Example 31 | PFA | SUS304 | Present | Present | Absent | SUS304 | 28.4 |
| Example 32 | PFA | Electropolished | Present | Present | Absent | Electropolished | 28.4 |
| | | SUS316L | | | | SUS316L | |
| Example 33 | PFA | SUS304 | Present | Present | Absent | SUS304 | 28.4 |
| Example 34 | PFA | Electropolished | Present | Present | Absent | Electropolished | 28.4 |
| | | SUS316L | | | | SUS316L | |
| Example 35 | PFA | SUS304 | Present | Present | Present | SUS304 | 28.4 |
| Comparative | PFA | SUS304 | Absent | Absent | Absent | Absent | — |
| Example 13 | | | | | | | |

| | Neutralization mechanism | | | | | | |
|---|---|---|---|---|---|---|---|
| | Conductive material of neutralization | | | | | | |
| | mechanism disposed on liquid | | | | | | |
| | flowing nozzle | | | | | | |
| | | Liquid | Liquid | Protective film-forming | | | |
| | | contact | contact | liquid chemical | | | Liquid |
| | Length | area | time | Protective film- | Acid or | Nonaqueous | flowing rate |
| | [mm] | [cm²] | [Sec] | forming agent | base | solvent | [m/sec] |
| Example 31 | 50 | 44.6 | 0.1 | Hexamethyl | Trimethylsilyl | PGMEA | 0.5 |
| | | | | disilazane | trifluoroacetate | | |
| Example 32 | 50 | 44.6 | 0.1 | Hexamethyl | Trimethylsilyl | PGMEA | 0.5 |
| | | | | disilazane | trifluoroacetate | | |
| Example 33 | 10 | 8.9 | 0.02 | Hexamethyl | Trimethylsilyl | PGMEA | 0.5 |
| | | | | disilazane | trifluoroacetate | | |
| Example 34 | 10 | 8.9 | 0.02 | Hexamethyl | Trimethylsilyl | PGMEA | 0.5 |
| | | | | disilazane | trifluoroacetate | | |
| Example 35 | 50 | 44.6 | 0.1 | Hexamethyl | Trimethylsilyl | PGMEA | 0.5 |
| | | | | disilazane | trifluoroacetate | | |
| Comparative | — | — | — | Hexamethyl | Trimethylsilyl | PGMEA | 0.5 |
| Example 13 | | | | disilazane | trifluoroacetate | | |

TABLE 14

| | Internal pressure (45° C.) | | | Concentration of | | |
|---|---|---|---|---|---|---|
| | At the start | At the end | | protective film-forming agent | | |
| | of high- | of high- | | Before high- | After high- | Rate of |
| | temperature | temperature | Change | temperature | temperature | decrease in |
| | storage | storage | rate | storage | storage | concentration |
| | [MPa] | [MPa] | [%] | [% by mass] | [% by mass] | [%] |
| Example 31 | 0.05 | 0.05 | 0 | 4.5 | 4.5 | 0 |
| Example 32 | 0.05 | 0.05 | 0 | 4.5 | 4.5 | 0 |
| Example 33 | 0.05 | 0.05 | 0 | 4.5 | 4.5 | 0 |
| Example 34 | 0.05 | 0.05 | 0 | 4.5 | 4.5 | 0 |
| Example 35 | 0.05 | 0.05 | 0 | 4.5 | 4.5 | 0 |
| Comparative | 0.05 | 0.05 | 0 | 4.5 | 4.5 | 0 |
| Example 13 | | | | | | |

| | Number of particles | | | | |
|---|---|---|---|---|---|
| | Before high- | After high- | Electrostatic potential | | |
| | temperature | temperature | After | After | After |
| | storage | storage | introduction | shaking | extraction |
| | [particles/mL] | [particles/mL] | [kV] | [kV] | [kV] |
| Example 31 | 9 | 17 | 0.5 | 0.5 | 0.1 |
| Example 32 | 8 | 14 | 0.6 | 0.5 | 0.2 |
| Example 33 | 8 | 13 | 0.7 | 0.6 | 0.2 |
| Example 34 | 6 | 9 | 0.6 | 0.7 | 0.1 |
| Example 35 | 10 | 19 | 0.6 | 0.1 | 0.1 |
| Comparative | 5 | 8 | 32 | 30 | 27 |
| Example 13 | | | | | |

### REFERENCE SIGNS LIST

A1, A2, A3, A4, A5, A6, B1, B2, B3: pressure feed container
1a, 1b: container body
2a: lining layer
2b: PFA layer (resin can body)
3: sample liquid
4: liquid flowing nozzle
5: nozzle for manometer
6: gas-port nozzle
7: sample-liquid-extracting nozzle (liquid flowing nozzle)
8: sample-liquid-introducing and -extracting nozzle (liquid contact nozzle)
9: manometer
10a, 10b: neutralization mechanism (neutralization mechanism disposed on liquid flowing nozzle)
11: rod-like body
12: neutralization mechanism (neutralization mechanism disposed on container body)
20: pressure feed container
21: container body
22: liquid flowing nozzle
23: gas-port nozzles
24: resin lining layer
25: liquid contact nozzle
26: neutralization mechanism (neutralization mechanism disposed on liquid flowing nozzle)

1. A pressure feed container configured to store a protective film-forming liquid chemical or a protective film-forming liquid chemical kit that is mixed into the protective film-forming liquid chemical, and to transfer a liquid upon application of pressure to the inside of the container, the protective film-forming liquid chemical being for forming a water-repellent protective film on at least surfaces of recessed portions of an uneven pattern formed on a surface of a wafer containing a silicon element at least at a part of the uneven pattern,
the protective film-forming liquid chemical comprising a nonaqueous organic solvent, a silylation agent, and an acid or a base,
the protective film-forming liquid chemical kit comprising a treatment liquid A containing a nonaqueous organic solvent and a silylation agent, and a treatment liquid B containing a nonaqueous organic solvent and an acid or a base,
the pressure feed container comprising a container body configured to contain a liquid selected from the protective film-forming liquid chemical, the treatment liquid A, and the treatment liquid B, and a liquid flowing nozzle configured such that the liquid flows therethrough to be introduced into the container body and/or to be extracted from the container body,
the container body comprising a metal can body in which a portion configured to contact the liquid is formed from a resin material, and
the liquid flowing nozzle being provided with a neutralization mechanism configured to reduce electrostatic potential in the liquid, and a liquid contact portion of the liquid flowing nozzle excluding the neutralization mechanism being formed from a resin material.

2. The pressure feed container according to claim 1,
wherein the neutralization mechanism is formed from a grounded conductive material.

3. The pressure feed container according to claim 2,
wherein the neutralization mechanism is formed such that, in the liquid flowing nozzle, a part of a surface configured to contact the liquid is formed from a grounded conductive material.

4. The pressure feed container according to claim 2,
wherein the neutralization mechanism is formed by providing a grounded conductive material in the liquid flowing nozzle such that the neutralization mechanism is configured to contact the liquid.

5. The pressure feed container according to claim 1,
wherein the container body is further provided with a neutralization mechanism configured to reduce electrostatic potential in the liquid.

6. The pressure feed container according to claim 5,
wherein the neutralization mechanism provided in the container body comprises a rod-like body in which a grounded conductive material is used to form a part of a surface configured to contact the liquid, and a resin material is used to form a liquid contact portion other than the conductive material.

7. The pressure feed container according to claim 1,
wherein the container body comprises a metal can body having an inner surface to which resin lining has been applied, or a metal can body covering an exterior of a resin can body.

8. A method for storing a protective film-forming liquid chemical or a protective film-forming liquid chemical kit that is mixed into the protective film-forming liquid chemical in a pressure feed container, the protective film-forming liquid chemical being for forming a water-repellent protective film on at least surfaces of recessed portions of an uneven pattern formed on a surface of a wafer containing a silicon element at least at a part of the uneven pattern,
the protective film-forming liquid chemical comprising a nonaqueous organic solvent, a silylation agent, and an acid or a base,
the protective film-forming liquid chemical kit comprising a treatment liquid A containing a nonaqueous organic solvent and a silylation agent, and a treatment liquid B containing a nonaqueous organic solvent and an acid or a base,
the method comprising:
introducing a liquid selected from the protective film-forming liquid chemical, the treatment liquid A, and the treatment liquid B into the pressure feed container according to claim 1 while applying pressure to the pressure feed container with an inert gas such that the pressure feed container has an internal pressure of 0.01 to 0.19 MPa in gauge pressure at 45° C.; and
storing the liquid in a temperature range from 0° C. to 45° C.

9. A method for transferring a protective film-forming liquid chemical or a protective film-forming liquid chemical kit that is mixed into the protective film-forming liquid chemical by using a pressure feed container configured to transfer a liquid upon application of pressure, the protective film-forming liquid chemical being for forming a water-repellent protective film on at least surfaces of recessed portions of an uneven pattern formed on a surface of a wafer containing a silicon element at least at a part of the uneven pattern,
the protective film-forming liquid chemical comprising a nonaqueous organic solvent, a silylation agent, and an acid or a base,
the protective film-forming liquid chemical kit comprising a treatment liquid A containing a nonaqueous organic solvent and a silylation agent, and a treatment liquid B containing a nonaqueous organic solvent and an acid or a base,
the pressure feed container comprising a container body configured to contain a liquid selected from the protective film-forming liquid chemical, the treatment liquid A, and the treatment liquid B,
the container body comprising a metal can body in which a portion configured to contact the liquid is formed from a resin material, and
the method comprising at least one of (1) and (2) below:
(1) introducing the liquid into the container body through a liquid flowing portion provided with a neutralization mechanism configured to reduce electrostatic potential in the liquid, wherein a liquid contact portion of the liquid flowing portion excluding the neutralization mechanism is formed from a resin material; and
(2) extracting the liquid from the container body containing the liquid through a liquid flowing portion provided with a neutralization mechanism configured to reduce electrostatic potential in the liquid, wherein a liquid contact portion of the liquid flowing portion excluding the neutralization mechanism is formed from a resin material.

10. The method according to claim 9,
wherein the neutralization mechanism is formed from a grounded conductive material.

11. The method according to claim 10,
wherein the neutralization mechanism is formed such that, in the liquid flowing portion, a part of a surface configured to contact the liquid is formed from a grounded conductive material.

12. The method according to claim 10,
wherein the neutralization mechanism is formed by providing a grounded conductive material in the liquid flowing portion such that the neutralization mechanism is configured to contact the liquid.

13. The method according to claim 9,
wherein the neutralization mechanism contacts the liquid for 0.001 to 100 seconds.

14. The method according to claim 9,
wherein the liquid flows through the liquid flowing portion at a rate of 0.01 to 10 msec.

15. The pressure feed container according to claim 2,
wherein the conductive material comprises at least one selected from the group consisting of steel, alloyed cast iron, maraging steel, stainless steel (such as electrolytically-polished SUS304 or SUS316L), nickel and its alloys, cobalt and its alloys, aluminum, magnesium and its alloys, copper and its alloys, titanium, zirconium, tantalum, niobium and its alloys, lead and its alloys, noble metal (e.g., gold, silver, platinum, palladium, rhodium, iridium, ruthenium, osmium) and its alloys, diamond, and glassy carbon.

16. The pressure feed container according to claim 2,
wherein the conductive material comprises a resin material containing at least one selected from the group consisting of steel, alloyed cast iron, maraging steel, stainless steel (such as electrolytically-polished SUS304 or SUS316L), nickel and its alloys, cobalt and its alloys, aluminum, magnesium and its alloys, copper and its alloys, titanium, zirconium, tantalum, niobium and its alloys, lead and its alloys, noble metal (e.g., gold, silver, platinum, palladium, rhodium, iridium, ruthenium, osmium) and its alloys, diamond, glassy carbon and carbon.

17. The pressure feed container according to claim 1,
the resin materials comprises at least one selected from the group consisting of high density polyethylene (HDPE), polypropylene (PP), 6,6-nylon, tetrafluoroethylene (PTFE), copolymers of tetrafluoroethylene and perfluoro alkyl vinyl ether (PFA), polychlorotrifluoroethylene (PCTFE), copolymers of ethylene and chlorotrifluoroethylene (ECTFE), copolymers of ethylene and tetrafluoroethylene (ETFE), and copolymers of tetrafluoroethylene and hexafluoropropylene (FEP).
